(19) United States
(12) Patent Application Publication
(10) Pub. No.: US 2023/0339808 A1
(43) Pub. Date: Oct. 26, 2023

(54) GLASS POWDER PRODUCTS FOR USE AS A POZZOLAN, AND PROCESSES AND SYSTEMS FOR THE PRODUCTION THEREOF

(71) Applicant: Rayan Investments Ltd., Moncton (CA)

(72) Inventor: Craig Szabo, Ottawa (CA)

(21) Appl. No.: 18/304,035

(22) Filed: Apr. 20, 2023

(30) Foreign Application Priority Data
Apr. 22, 2022 (CA) 3156214

(51) Int. Cl. C04B 7/12; B03B 9/06

(52) U.S. Cl. CPC C04B 7/12; B03B 9/06; C04B 2103/54

(57) ABSTRACT

Provided herein are processes for preparing a glass powder pozzolan product, the process including steps of: providing a crushed and clean waste glass; sorting the waste glass post pulverization through a process to take a coarse stream; adding a fine stream collected in the process and milling the coarse and fine streams to provide the glass powder pozzolan product. Glass powder pozzolan products, as well as systems for producing such glass powder pozzolan products, are also provided.

### FIELD OF INVENTION

The present invention relates generally to glass powder products. More specifically, the present invention relates to fine glass powder products for use as a pozzolan, as well as systems and processes for the production thereof.

### BACKGROUND

Fine powder products have a wide variety of uses in industrial, commercial, and consumer operations and products. By way of example, fine powder products are commonly employed in diverse applications spanning from use as an abrasive in sand blasting, to use in concrete, to use as a filler or extender in paints or other such coatings. Fine powder products have been used as fillers/enhancers in concrete for numerous years. Common fine powder products include, among others, those produced from fly ash, blast furnace slag and silica fume, which have been used in concrete and concrete composites. Glass as a pozzolan is recognized for use as a cement replacement through ASTM 1866 and CSA A3000-18.

Glass-based fine powder products are desirable for a number of applications, given that glass is a generally inert material in many environments and has an affinity for water. There are many sources of relatively accessible glass material, including post-consumer glass waste such as bottles returned for recycling. Unfortunately, however, converting post-consumer glass waste and other such glass sources into suitable glass powder products can be quite challenging, particularly because post-consumer glass waste is typically contaminated with a number of undesirable materials, which may include paper, plastic, aluminum, and organics, for example. Sorting and cleaning post-consumer waste glass materials can be energy and resource intensive, and can require complex apparatus. Traditional post-consumer glass waste treatment operations commonly involve a washing phase employing liquids such as water or water-based cleaning solutions, which then require a heating/drying phase to remove the liquid, creating further energy demand.

Furthermore, generating glass powder products at the ultra-fine grade having a narrow particle size range, which may be desirable in certain applications, presents a significant challenge, particularly where post-consumer glass waste is used as the feedstock for generating the glass powder product. The challenges associated with production of ultra-fine glass particles may include cleanliness of the glass, such that the loss on ignition (LOI) is too high, as well as the consistency of quality factors. The previous glass powders were referenced as general industry offerings, which may be coarser, have a wider particle size distribution, inconsistent LOI and undefined colour, in comparison to the glass powders produced herein.

Alternative, additional, and/or improved glass powder products, as well as processes and systems for the preparation thereof, are desirable.

### SUMMARY OF INVENTION

Described herein are glass powder pozzolan products, and processes and systems for the generation thereof. Glass-based fine powder pozzolan products are desirable for a variety of industrial and commercial applications, including as performance enhancers for concrete and other construction materials/admixtures. While sources of glass are readily available as post-consumer waste glass, the use of such glass to prepare fine powder pozzolan products is challenging since post-consumer waste glass typically contains a number of contaminants, which interfere with processing and glass powder product production.

Accordingly, provided herein are processes and systems for preparing glass powder pozzolan products. Glass powder pozzolan products are also provided. Processes and systems described herein may be used, for example, to prepare ultra-fine glass powder products from post-consumer waste glass (such as soda-lime type waste glass), the ultra-fine glass powder products having a generally leptokurtic particle size distribution curve, as are desirable for concrete mixtures and admixtures. In certain embodiments, by producing simultaneously a coarse stream and a fine stream, and milling the coarse stream and the fine stream together, such ultra-fine glass powder products having a generally leptokurtic particle size distribution may be prepared from a crushed waste glass.

In an embodiment, there is provided herein a process for preparing a glass powder pozzolan product, the process comprising:
providing a crushed waste glass with a loss on ignition (LOI) less than 0.5% and moisture less than 0.5%;
scalping the desired glass feed stream from the production of other glass products to produce a primary stream;
separating the primary stream based on size to provide a coarse stream, comprising a pulverized glass within a predetermined first particle size range; and
milling at least a portion of the coarse stream to generate a fine stream, comprising glass within a predetermined second particle size range; and
milling at least a portion of the coarse stream and at least a portion of the fine stream to provide the glass powder pozzolan product.

In another embodiment, there is provided herein a process for preparing a glass powder pozzolan product, the process comprising steps of:
providing a crushed waste glass with a loss on ignition (LOI) less than 0.5% and moisture less than 0.5%;
scalping the desired glass feed stream from the production of other coarse glass products to produce a coarse stream comprising a pulverized glass within a predetermined first particle size range;
adding a fine stream comprising glass within a predetermined second particle size range to the primary stream; and
milling at least a portion of the coarse stream and at least a portion of the fine stream to provide the glass powder pozzolan product.

In another embodiment of the process, the step of providing the crushed waste glass may comprise providing a waste glass input feed and crushing the waste glass input feed to provide the crushed waste glass. The waste glass input feed may comprise any suitable glass feed, such as a feed of post-consumer waste glass. In a further embodiment, providing a waste glass input feed may comprise glass with LOI<0.5%, moisture<0.5%.

In still another embodiment of the process or processes above, the process may be a dry process.

In another embodiment of the process or processes above, the process may further comprise transferring at least a portion of a primary stream to a crusher, crushing the primary stream, and repeating the process using the crushed primary stream as at least a portion of the crushed waste glass.

In yet another embodiment of the process or processes above, the process may further comprise:
optionally, pre-screening the primary stream to remove large contaminants; and
treating the primary stream in an Eddy separator to remove aluminum or other non-ferrous metals and/or residual plastic before the step of transferring the primary stream to the crusher.

In still another embodiment of the process or processes above, the step of separating may comprise screening the primary stream on a screener.

In yet another embodiment of the process or processes above, the screener may comprise at least one screen for separating the primary stream into a coarse stream and the fine stream.

In another embodiment of the process or processes above, the screener may comprise at least one screen for separating the primary stream into the coarse stream.

In another embodiment of the process or processes above, the screener may be a multi-deck screener comprising an upstream deck with a coarse mesh screen outputting the coarse stream and a downstream deck with a fine mesh screen outputting the fine stream.

In yet another embodiment of the process or processes above, the fine mesh screen of the downstream deck may have a mesh size of about 90 to about 150 mesh, or higher.

In yet another embodiment of the process or processes above, materials which pass through the coarse mesh screen but which do not pass through the fine mesh screen may be output as a reject stream.

In still another embodiment of the process or processes above, the multi-deck screener may further comprise one or more intermediate decks each with an intermediate mesh screen, for outputting one or more reject streams.

In another embodiment of the process or processes above, the one or more intermediate decks may be for outputting two or more reject streams, each having a different particle size range.

In yet another embodiment of the process or processes above, the multi-deck screener may comprise 1 to 3 sequentially arranged intermediate decks of progressively finer mesh size, the intermediate decks arranged downstream of the upstream deck and upstream of the downstream deck.

In still another embodiment of the process or processes above, the screens of the multi-deck screener may become progressively finer moving through the multi-deck screener.

In yet another embodiment of the process or processes above, the process may further comprise:
using at least a portion of at least one reject stream to generate another glass-based product;
transferring at least a portion of at least one reject stream to a crusher, crushing the reject stream, and repeating the process using the crushed reject stream as at least a portion of the crushed waste glass; or both.

In another embodiment of the process or processes above, the process may further comprise a step of:
optionally, pre-screening the reject stream to remove large contaminants; and
treating the reject stream in an Eddy separator to remove aluminum or other non-ferrous metals and/or residual plastic before the step of using the reject stream or transferring the reject stream to the crusher.

In still another embodiment of the process or processes above, the process may further comprise sorting at least a portion of the glass powder product in an air classifier to provide a glass powder pozzolan product stream within a predetermined particle size range, and a reject glass powder product stream comprising glass powder excluded from the glass powder pozzolan product stream.

In yet another embodiment of the process or processes above, the process may further comprise:
optionally, mixing at least a portion of the reject glass powder product stream with at least a portion of the coarse stream, at least a portion of the fine stream, or with a combined stream comprising at least a portion of the coarse stream and at least a portion of the fine stream; and
re-milling to generate additional glass powder pozzolan product.

In yet another embodiment of the process or processes above, the air classifier may recover ultra-fine glass powder pozzolan product based on material mass to air mass ratio within the secondary air classifier, thereby providing an ultra-fine glass powder pozzolan product having a leptokurtic particle size curve as the glass powder pozzolan product stream.

In still another embodiment of the process or processes above, the glass powder pozzolan product may comprise an ultra-fine glass powder product having a predominantly leptokurtic particle size curve.

In another embodiment of the process or processes above, the process may further comprise a step of adjusting the ratio of the coarse stream to the fine stream to be milled, so as to provide the glass powder pozzolan product as an ultra-fine glass powder pozzolan product having a target leptokurtic particle size distribution.

In yet another embodiment of the process or processes above, the process may further comprise generating at least a portion of the crushed waste glass or the waste glass input feed from post-consumer waste glass.

In still another embodiment of the process or processes above, the step of generating may comprise at least one of:
crushing the post-consumer waste glass;
treating the post-consumer waste glass in a high-temperature dryer to destroy paper, light plastic, and organic contaminants; and
removing ferrous metal contaminants from the post-consumer waste glass.

In another embodiment of the process or processes above, the step of generating may comprise treating the post-consumer waste glass in the high-temperature dryer, and wherein the high-temperature dryer comprises a rotary kiln dryer and/or a tumbler dryer.

In yet another embodiment of the process or processes above, the step of generating may comprise treating the post-consumer waste glass in the high-temperature dryer, and may further comprise cooling the post-consumer waste glass on a fluidized bed cooler.

In yet another embodiment of the process or processes above, the step of generating may comprise removing ferrous metal contaminants from the post-consumer waste glass, and wherein the ferrous metal contaminants are removed using belt in-line magnets.

In another embodiment of the process or processes above, the crushed waste glass may comprise glass from post-consumer waste glass which has been color-sorted.

In still another embodiment of the process or processes above, the crushed waste glass may comprise clear or white bottle glass, and is substantially free of colored glass.

In still another embodiment of the process or processes above, the crushed waste glass may comprise mixed coloured glass with a mean of green/flint glass ranging from 50% to 85%. In yet another embodiment of the process or processes above, the glass powder pozzolan product may comprise a particle size D50 range from about 7 microns to about 2 microns.

In another embodiment of the process or processes above, the glass powder pozzolan product may comprise a brightness level at or exceeding 90 L on a standardized CIE color scale (65/10 observant). In another embodiment, the glass powder pozzolan product may comprise a brightness level at or exceeding 95 L on a standardized CIE color scale (65/10 observant).

In yet another embodiment of the process or processes above, at least one vertical impact crusher may be used for crushing to provide the crushed waste glass.

In yet another embodiment of the process or processes above, the process may further comprise a step of periodically reversing a direction of a belt used for transporting the primary stream to clear accumulated large non-glass waste into a trash stream.

In another embodiment of the process or processes above, the predetermined first particle size range of the coarse stream may be from about 5 to about 800 microns.

In yet another embodiment of the process or processes above, the predetermined second particle size range of the fine stream may be from about 2 to about 200 microns.

In still another embodiment of the process or processes above, a ratio of the coarse stream to the fine stream provided for milling may be about 80:20, and the coarse stream and the fine stream may be provided as a substantially or suitably heterogeneous mixture.

In yet another embodiment of the process or processes above, the coarse stream may be milled in a ball mill prior to milling with the fine stream.

In another embodiment of the process or processes above, the step of milling to provide the glass powder pozzolan product may comprise milling in a ball mill with a charge porosity configured for production of ultra-fines.

In yet another embodiment of the process or processes above, the step of milling to provide the fine stream may comprise milling in a ball mill with a charge porosity configured for production of fines.

In another embodiment, there is provided herein a process for preparing a glass powder pozzolan product, the process comprising:
providing a coarse stream comprising a pulverized glass within a first particle size range;
milling the coarse stream to provide a fine stream comprising a pulverized glass within a second particle size range; and
milling the coarse stream and the fine stream to provide the glass powder product.

In another embodiment, there is provided herein a process for preparing a glass powder pozzolan product, the process comprising:
providing a coarse stream comprising a pulverized glass within a first particle size range;
providing a fine stream comprising a pulverized glass within a second particle size range; and
milling the coarse stream and the fine stream to provide the glass powder product.

In another embodiment of the process or system, the first particle size range and the second particle size range may be different. In yet another embodiment of the process, the first particle size range and the second particle size range may be partially overlapping. In still another embodiment, the first particle size range and the second particle size range may not overlap In yet another embodiment, the coarse stream may be finer than the fine stream. In certain embodiments, the combined stream may have a bi-modal particle size distribution.

In another embodiment, there is provided herein a glass powder pozzolan product made by a process as described herein.

In yet another embodiment, there is provided herein a concrete mixture comprising a glass powder product as described herein as a cement replacement (per ASTM 1866 and CSA A 3000-2018).

In another embodiment, there is provided herein a system for preparing a glass powder pozzolan product, the system comprising:
a cleaned crushed waste glass input;
a mill configured to receive at least a portion of a coarse stream comprising a pulverized glass of a predetermined first particle size range, to mill the coarse stream to provide a fine stream comprising a pulverized glass of a predetermined second particle size range; and
a mill configured to receive at least a portion of the coarse stream comprising a pulverized glass of a predetermined first particle size range and at least a portion of the fine stream, having a predetermined second particle size range, or a mixture thereof, to mill the coarse stream and the fine stream to provide the glass powder pozzolan product.

In another embodiment, there is provided herein a system for preparing a glass powder pozzolan product, the system comprising:
a cleaned crushed waste glass input;
a mill configured to receive at least a portion of the coarse stream comprising a pulverized glass of a predetermined first particle size range and at least a portion of the fine stream, having a predetermined second particle size range, or a mixture thereof, to mill the coarse stream and the fine stream to provide the glass powder pozzolan product.

In another embodiment of the system, the system may further comprise a crusher configured to receive a waste glass input feed, to crush the waste glass input feed to provide a crushed waste glass, and to provide the crushed waste glass to the crushed waste glass input.

In still another embodiment of the system or systems above, the system may be a dry system, which does not input water, or may input water for cooling apparatus but which does not wet the glass.

In yet another embodiment of the system or systems above, the separator may be in communication with a crusher, and configured to transfer at least a portion of the primary stream to the crusher to generate additional crushed glass waste.

In yet another embodiment of the system or systems above, the system may further comprise:
an Eddy separator in communication with the separator and configured to receive the primary stream from the separator and to treat the primary stream to remove aluminum or other non-ferrous metals and/or residual plastic therefrom, the Eddy separator further in communication with the crusher for transferring the primary stream to the crusher following treatment.

In another embodiment of the system or systems above, the system may further comprise a pre-screen configured to remove large contaminants from the primary stream prior to the primary stream entering the Eddy separator.

In another embodiment of the system or systems above, the separator may comprise a screener.

In yet another embodiment of the system or systems above, the screener may comprise at least one screen for separating the primary stream into the coarse stream and the fine stream.

In yet another embodiment of the system or systems above, the screener may comprise at least one screen for separating the primary stream into the coarse stream.

In still another embodiment of the system or systems above, the screener may be a multi-deck screener comprising an upstream deck with a coarse mesh screen configured to output the coarse stream and a downstream deck with a fine mesh screen configured to output the fine stream.

In yet another embodiment of the system or systems above, the fine mesh screen of the downstream deck may have a mesh size of about 90 to about 150 mesh, or higher.

In another embodiment of the system or systems above, the system may be configured such that materials which pass through the coarse mesh screen but which do not pass through the fine mesh screen may be output as a reject stream.

In yet another embodiment of the system or systems above, the multi-deck screener may further comprise one or more intermediate decks each with an intermediate mesh screen, configured for outputting one or more reject streams.

In still another embodiment of the system or systems above, the one or more intermediate decks may be for outputting two or more reject streams, each having a different particle size.

In another embodiment of the system or systems above, the multi-deck screener may comprise 1 to 3 sequentially arranged intermediate decks of progressively finer mesh size, the intermediate decks arranged downstream of the upstream deck and upstream of the downstream deck.

In yet another embodiment of the system or systems above, the screens of the multi-deck screener may become progressively finer moving through the multi-deck screener.

In another embodiment of the system or systems above, the system may be configured to transfer at least a portion of at least one reject stream to a crusher to generate additional crushed waste glass.

In yet another embodiment of the system or systems above, the system may further comprise an Eddy separator configured to receive at least a portion of at least one reject stream and to treat the intermediate stream to remove aluminum or other non-ferrous metals and/or residual plastic therefrom.

In still another embodiment of the system or systems above, the Eddy separator may be in communication with the crusher for transferring the reject stream to the crusher following treatment for further processing to generate additional crushed waste glass.

In yet another embodiment of the system or systems above, the system may further comprise a pre-screen configured to remove large contaminants from the reject stream prior to the reject stream entering the Eddy separator.

In yet another embodiment of the system or systems above, the system may further comprise an air classifier in communication with the mill and configured to receive at least a portion of the glass powder product therefrom and to sort the glass powder product to provide a glass powder pozzolan product stream within a predetermined particle size range, and a reject glass powder product stream comprising glass powder excluded from the glass powder pozzolan product stream.

In another embodiment of the system or systems above, the air classifier may be in communication with the mixing unit and/or the mill, and is configured to return the reject glass powder product stream back to the mill either alone or mixed with the coarse stream, the fine stream, or both, or a combined stream comprising the coarse stream and the fine stream, for further milling to generate additional glass powder pozzolan product.

In still another embodiment of the system or systems above, the air classifier may be configured to recover ultra-fine glass powder product based on material mass to air mass ratio within the air classifier, thereby providing an ultra-fine glass powder product having a target leptokurtic particle size curve as the glass powder pozzolan product stream.

In another embodiment of the system or systems above, the system may be configured to provide the glass powder product comprising an ultra-fine glass powder product having a leptokurtic particle size curve.

In yet another embodiment of the system or systems above, the system may be configured to allow adjustment of the ratio of the coarse stream to the fine stream to be milled, so as to provide the glass powder product as an ultra-fine glass powder product having a target leptokurtic particle size distribution.

In yet another embodiment of the processes or systems herein, at least a portion of the crushed waste glass or the waste glass input feed may be generated from a post-consumer waste glass, and wherein the system may further comprise at least one of:
an initial crusher for crushing the post-consumer waste glass;
a high-temperature dryer configured to destroy paper, light plastic, and organic contaminants contained in the post-consumer waste glass; and
a magnet for removing ferrous metal contaminants from the post-consumer waste glass;
which may be arranged along a path followed by the post-consumer waste glass, the path leading to the crushed waste glass input.

In yet another embodiment of the system or systems above, the system may comprise a crusher configured to receive a waste glass input feed, to crush the waste glass input feed to provide a crushed waste glass, and to provide the crushed waste glass to the crushed waste glass input; and wherein the path leads the post-consumer waste glass to the crusher, the post-consumer waste glass providing at least a portion of the waste glass input feed for the crusher.

In another embodiment of the system or systems above, the high temperature dryer may be in communication with the crusher through a fluidized bed cooler configured along the path to cool the post-consumer waste glass.

In yet another embodiment of the system or systems above, the high-temperature dryer may comprise a rotary kiln and/or a tumbler dryer.

In still another embodiment of the system or systems above, the magnet may be configured with a conveyor belt for removing ferrous metal contaminants from the post-consumer waste glass during transfer thereof.

In another embodiment of the system or systems above, the crusher may be a vertical impact crusher.

In yet another embodiment of the system or systems above, the system may further comprise a belt for transferring the primary stream, wherein the belt is configured to periodically reverse direction to clear accumulated large non-glass waste into a trash stream.

In still another embodiment of the system or systems above, the separator may be configured to provide the coarse stream with the predetermined first particle size range being about 5 to about 800 microns.

In another embodiment of the system or systems above, the separator may be configured to provide the fine stream with the predetermined second particle size range being about 2 to about 200 microns.

In yet another embodiment of the system or systems above, the system may be configured to provide a feed rate of the coarse stream and the fine stream to the mill, or a mixing unit upstream thereof, such that a ratio of the coarse stream to the fine stream being milled is about 80:20, and such that the coarse stream and the fine stream are provided as a substantially heterogeneous mixture.

In another embodiment of the system or systems above, the system may further comprise a second mill configured to receive the fine stream from the separator and to mill the fine stream prior to milling with the coarse stream.

In yet another embodiment of the system or systems above, the second mill may comprise a ball mill.

In another embodiment of the system or systems above, the mill may be configured to receive the coarse stream and the fine stream, either separately or as a combined stream, and to perform milling to provide the glass powder product, wherein the mill comprises a ball mill with a charge porosity configured for production of ultra-fines.

In another embodiment of the system or systems above, the screener may comprise at least one screen for separating the primary stream into the coarse stream.

In yet another embodiment, there is provided herein a process for preparing a glass powder pozzolan product from a waste glass input feed, the process comprising steps of:
crushing the waste glass input feed in a crusher to provide a crushed waste glass;
scalping the desired glass feed stream from the production of other coarse glass products to produce a primary stream;
sorting the crushed waste glass in a separator to provide a coarse stream comprising a pulverized glass within a predetermined first particle size range;
milling the coarse stream to provide a fine stream comprising a pulverized glass within a predetermined second particle size range;
adding the fine stream to the coarse stream; and
milling the coarse stream and the fine stream to provide the glass powder pozzolan product.

In yet another embodiment, there is provided herein a process for preparing a glass powder pozzolan product from a waste glass input feed, the process comprising steps of:
crushing the waste glass input feed in a crusher to provide a crushed waste glass;
scalping the desired glass feed stream from the production of other coarse glass products to produce a primary stream;
sorting the crushed waste glass in a separator to provide a coarse stream and a fine stream, the coarse stream comprising a pulverized glass within a predetermined first particle size range, and a fine stream comprising crushed waste glass within a predetermined second particle size range;
adding the fine stream to the coarse stream; and
milling the coarse stream and the fine stream to provide the glass powder pozzolan product.

In still another embodiment of the process, the process may further comprise a step of returning the primary stream to the crusher and using the primary stream as at least a portion of the waste glass input feed to provide additional crushed waste glass for the process.

In another embodiment, there is provided herein a system for preparing a glass powder product from a waste glass input feed, the system comprising:
a crusher configured to crush the waste glass input feed to provide a crushed waste glass, and to provide the crushed waste glass to a crushed waste glass input;
a separator in communication with the crushed waste glass input and configured to receive
the crushed waste glass and sort the crushed waste glass to provide a primary stream;
a separator configured to receive the primary stream therefrom and separate the primary stream based on size to provide a coarse stream comprising a pulverized glass within a predetermined first particle size range;
a mill configured to receive the coarse stream, and to mill the coarse stream to provide a fine stream comprising a pulverized glass within a predetermined second particle size range; and
a mill configured to receive the coarse stream and the fine stream, either separately or as a combined stream, and to mill the coarse stream and the fine stream to provide the glass powder pozzolan product.

In another embodiment, there is provided herein a system for preparing a glass powder product from a waste glass input feed, the system comprising:
a crusher configured to crush the waste glass input feed to provide a crushed waste glass, and to provide the crushed waste glass to a crushed waste glass input;
a separator in communication with the crushed waste glass input and configured to receive the crushed waste glass and sort the crushed waste glass to provide a primary stream;
a separator configured to receive the primary stream therefrom and separate the primary stream based on size to provide a coarse stream comprising a pulverized glass within a predetermined first particle size range and a fine stream, the fine stream having a predetermined second particle size range; and
a mill configured to receive the coarse stream and the fine stream having a predetermined second particle size range, either separately or as a combined stream, and to mill the coarse stream and the fine stream to provide the glass powder pozzolan product.

In another embodiment, the system may be configured to return the primary stream to the crusher and use the primary stream as at least a portion of the waste glass input feed to provide additional crushed waste glass.

In another embodiment, there is provided herein a process for preparing a glass powder pozzolan product, the process comprising:
milling a feedstock comprising a coarse stream to provide a fine stream;
milling the coarse stream and the fine stream to provide the glass powder product;
wherein the coarse stream comprises a pulverized glass having a D50 of about 100 to about 150 micron; and
wherein the fine stream comprises a pulverized glass having a D50 of about 20 to about 50 micron.

In another embodiment, there is provided herein a process for preparing a glass powder pozzolan product, the process comprising:
milling a feedstock comprising a coarse stream and a fine stream to provide the glass powder product,
wherein the coarse stream comprises a pulverized glass having a D50 of about 100 to about 150 micron; and
wherein the fine stream comprises a pulverized glass having a D50 of about 20 to about 50 micron.

In another embodiment of the process, the coarse stream may have a topcut (D98) of about 120 to about 700 micron. In another embodiment, the coarse stream may have a D10 of about 20 to about 50 micron. In yet another embodiment, the fine stream may have a topcut (D98) of about 80 to about 140 micron. In still another embodiment, the fine stream may have a D10 of about 5 to about 15 micron.

In yet another embodiment of the process or processes above, the coarse stream and the fine stream may be combined to form a combined stream prior to milling.

In yet another embodiment of the process or processes above, the combined stream may comprise a heterogeneous mixture of the coarse stream and the fine stream.

In still another embodiment of the process or processes above, the combined stream may comprise a plurality of interspersed layers of the coarse stream and layers of the fine stream.

In yet another embodiment of the process or processes above, the coarse stream and the fine stream may be separately supplied to a mill for the step of milling.

In another embodiment, there is provided herein a system for preparing a glass powder product, the system comprising:
a mill for milling a feedstock comprising a coarse stream to provide a fine stream;
one or more inputs for supplying the coarse stream, either separately or in combination, to the mill;
a mill for milling a feedstock comprising the coarse stream and the fine stream to provide the glass powder product;
wherein the coarse stream comprises a pulverized glass having a D50 of about 100 to about 150 micron; and
wherein the fine stream comprises a pulverized glass having a D50 of about 20 to about 50 micron.

In another embodiment, there is provided herein a system for preparing a glass powder product, the system comprising:
a mill for milling a feedstock comprising a coarse stream and a fine stream to provide the glass powder product;
one or more inputs for supplying the coarse stream and the fine stream, either separately or in combination, to the mill;
wherein the coarse stream comprises a pulverized glass having a D50 of about 100 to about 150 micron; and
wherein the fine stream comprises a pulverized glass having a D50 of about 20 to about 50 micron.

In another embodiment of the system, the coarse stream may have a topcut (D98) of about 120 to about 700 micron. In another embodiment, the coarse stream may have a D10 of about 20 to about 50 micron. In yet another embodiment, the fine stream may have a topcut (D98) of about 80 to about 140 micron. In still another embodiment, the fine stream may have a D10 of about 5 to about 15 micron.

In yet another embodiment of the system or systems above, the coarse stream and the fine stream may be combined to form a combined stream, which is supplied to the mill by the one or more inputs.

In still another embodiment of the system or systems above, the combined stream may comprise a heterogeneous mixture of the coarse stream and the fine stream.

In yet another embodiment of the system or systems above, the combined stream may comprise a plurality of interspersed layers of the coarse stream and layers of the fine stream.

In still another embodiment of the system or systems above, the coarse stream and the fine stream may be separately supplied to the mill by the one or more inputs.

In another embodiment, there is provided herein a process for preparing a glass powder pozzolan product, the process comprising steps of:
providing a crushed waste glass with a loss on ignition (LOI) less than 0.5% and moisture less than 0.5%;
sorting the crushed waste glass with a separator to provide a coarse stream comprising a pulverized glass within a predetermined first particle size range, and a fine stream having a predetermined second particle size range; and
milling at least a portion of the coarse stream and at least a portion of the fine stream to provide the glass powder product.

In another embodiment, there is provided herein a process for preparing a glass powder pozzolan product, the process comprising steps of:
providing a crushed waste glass with a loss on ignition (LOI) less than 0.5% and moisture less than 0.5%;
sorting the crushed waste glass with a separator to provide a coarse stream comprising a pulverized glass within a predetermined first particle size range;
milling the coarse stream to provide a fine stream comprising a pulverized glass within a predetermined second particle size range; and
milling at least a portion of the coarse stream and at least a portion of the fine stream to provide the glass powder product.

In still another embodiment, there is provided herein a system for preparing a glass powder pozzolan product, the system comprising:
a crushed waste glass input;
a separator in communication with the crushed waste glass input and configured to receive a crushed waste glass therefrom and sort the crushed waste glass to provide a coarse stream comprising a pulverized glass within a predetermined first particle size range, and a fine stream having a predetermined second particle size range; and
a mill configured to receive at least a portion of the coarse stream and at least a portion of the fine stream, or a mixture thereof, and to mill the coarse stream and the fine stream to provide the glass powder product.

In still another embodiment, there is provided herein a system for preparing a glass powder pozzolan product, the system comprising;
a crushed waste glass input;
a separator in communication with the crushed waste glass input and configured to receive a crushed waste glass therefrom and sort the crushed waste glass to provide a coarse stream comprising a pulverized glass within a predetermined first particle size range;
a mill configured to receive at least a portion of the coarse stream, and to mill the coarse stream to provide a fine stream comprising a pulverized glass within a predetermined second particle size range; and
a mill configured to receive at least a portion of the coarse stream and at least a portion of the fine stream, or a mixture thereof, and to mill the coarse stream and the fine stream to provide the glass powder product

In yet another embodiment, there is provided herein a recycled glass-based powder pozzolan product comprising one or more of: a brightness L* (CIE) of about 90% or greater;
an LOI of 0.5% or less;
a moisture of 0.5% or less;

In yet another embodiment, the recycled glass-based powder pozzolan product may further comprise a brightness L* (CIE) of about 96% or greater.

In another embodiment, the recycled glass-based powder pozzolan product may have a substantially leptokurtic particle size distribution.

In yet another embodiment, the recycled glass-based powder pozzolan product may further comprise one or more of:
a particle size range based on mean of about 2.5 to about 6 microns;
a particle size D50 of about 2 microns to about 7 microns;
a specific surface area range of about 16000 to about 27000 cm²/mL;
a particle size D10 of about 0.7 microns to about 2 microns;
a particle size D98 of about 6 microns to about 20 microns;
a refractive index of about 1.5;
a round or angular particle shape;
a micro-crystalline silica content of about 0; or
any combination thereof.

### BRIEF DESCRIPTION OF DRAWINGS

FIGS. 1(A), 1(B) and 1(C) show schematic diagrams of an embodiment of a system for preparing a glass powder product as described herein, the system performing an embodiment of a process as described herein. In FIG. 1(A), the system is generating a coarse stream and a fine stream from a crushed waste glass, in FIG. 1(B) the system is combining the coarse stream and the fine stream to provide a combined stream, and in FIG. 1(C) the system is combining the coarse stream and the fine stream to provide a combined stream in a feed bin;

FIG. 2 shows a schematic diagram of additional downstream components of the system embodiment depicted in FIG. 1 or FIG. 3, wherein the system further comprises a ball mill for milling the combined stream to provide the glass powder product;

FIG. 3 shows a schematic diagram of another embodiment of a system for preparing a glass powder product as described herein, the system performing another embodiment of a process as described herein. In FIG. 3, the depicted system is generating a coarse stream from a crushed waste glass using a separator (i.e. a screener);

FIG. 4 shows a schematic diagram of additional downstream components of the system embodiment depicted in FIG. 1 or 3, wherein the system further comprises a ball mill for milling the coarse stream which may be supplied to a first ball mill which performs milling to generate a fine stream, the fine stream may be sent with the coarse stream to a second ball mill configured for ultra-fine processing for further milling to provide an ultra fine glass powder product;

FIG. 5 shows a schematic diagram of additional upstream components of the system embodiment depicted in FIGS. 1 and 3, where the system further comprises a crusher and a high temperature dryer for generating crushed waste glass from a waste glass input feed;

FIG. 6 shows a flow diagram of an embodiment of a process as described herein which may be performed on the system embodiment depicted in FIGS. 1, 2 and 5;

FIG. 7 shows a flow diagram of an embodiment of a process as described herein which may be performed on the system embodiment depicted in FIGS. 3-5;

FIG. 8 shows an example of a particle size distribution of an example of a combined stream comprising a coarse stream and a fine stream as described herein, having a bimodal particle size distribution.

### DETAILED DESCRIPTION

Described herein are glass powder pozzolan products, and processes and systems for the generation thereof. It will be appreciated that embodiments and examples are provided for illustrative purposes intended for those skilled in the art, and are not meant to be limiting in any way.

While sources of glass are readily available as post-consumer waste glass, the use of such glass to prepare fine powder products has traditionally been challenging since post-consumer waste glass typically contains a number of contaminants, which interfere with processing and glass powder product production, as for example, coarser products may not be effective as a cement replacement. Accordingly, provided herein are processes and systems for preparing glass powder products, as well as glass powder products generated therefrom. Processes and systems described herein may be used, for example, to prepare ultra-fine glass powder products from post-consumer waste glass, the ultra-fine glass powder products having a generally leptokurtic particle size distribution curve as may be desirable for concrete mixtures as a cement replacement. In certain embodiments, by producing a coarse stream and a fine stream, and milling the combined coarse stream and fine stream, such ultra-fine glass powder products having a generally leptokurtic particle size distribution may be prepared from a crushed waste glass. Ultra-fine, as used herein, is classified as powders with D50 under about 5, whereas fine may be anything with greater than 96% passing 45 microns and a D50 of around 10 to 12 microns.

### Systems and Processes for Preparing Glass Powder Products

In an embodiment, there is provided herein a system or process for preparing a glass powder product, comprising:
a crushed waste glass input;
a mill configured to receive at least a portion of a coarse stream and at least a portion of a fine stream, or a mixture thereof, to mill the coarse stream and the fine stream to provide the glass powder product.

In certain embodiments, it is contemplated that the mixture of the coarse stream and the fine stream may be a substantially homogeneous mixture in the feed bin; however, typically the mixture of the coarse stream and the fine stream may be a substantially heterogeneous mixture of the coarse stream and the fine stream, with the mixture typically comprising a plurality of interspersed layers of the first stream and layers of the fine stream.

In certain embodiments, the mill will be supplied with at least some of the coarse stream, and at least some of the fine stream. Milling may cause mixing of the coarse stream and the fine stream, and provide the glass powder product.

As will be understood, the crushed waste glass input may input any suitable crushed waste glass feedstock, which may comprise contaminants typically found in post-consumer waste glass, into the system. The crushed waste glass feedstock may comprise finely crushed glass particles, as well as coarser glass particles.

The primary stream may be provided to a separator, which separates the primary stream based on size to provide the coarse stream and the fine stream. The separator may include any separation unit suitable for sorting the primary stream input into at least a fine stream and a coarse stream. By way of example, the separator may comprise a screener, air classifier or vibrating deck screen unit. The fine stream may comprise glass particles below a predetermined upper threshold size, and may be defined by a mechanical configuration of the separator. For example, the separator may comprise a vibrating screen unit having at least one screen, with a mesh size of the screen determining which particles are sorted to the fine stream and which particles are sorted to the coarse stream. In typical embodiments, the screener may be a vibratory deck screener. By way of example, in certain embodiments, screen mesh size, screen vibratory mode, and/or screen feed rate may be adjusted to achieve the desired particle size range of the fine stream, the coarse stream, the reject stream or any combination thereof.

The fine stream output from the separator may comprise glass particles having a predetermined second particle size range (i.e. the fine stream may comprise a population of pulverized glass particles with sizes falling within a predetermined range). The predetermined second particle size range may be defined by an upper end size cut-off, or may be defined by an upper end size cut-off and a lower end size cut-off, which may be implemented by configuring settings of the separator accordingly. The predetermined second particle size range may be selected to suit the particular application, such that the fine stream comprises pulverized glass particles each having a particle size which is below an upper threshold size and optionally above a lower threshold size, and having a population mean particle size within the predetermined second particle size range. The fine stream may comprise pulverized glass particles, with a particle size distribution having an upper size cut-off corresponding with the upper threshold size, and optionally having a lower size cut-off corresponding with the lower threshold size.

In certain embodiments of the systems or processes described herein, the separator may be configured such that the predetermined first particle size range of the coarse stream and the predetermined second particle size range of the fine stream are different from each other. In certain embodiments, the separator may be configured such that the predetermined first particle size range and the predetermined second particle size range are partially overlapping. In certain embodiments, the separator may be configured such that the predetermined first particle size range and the predetermined second particle size range do not overlap. In certain embodiments, the coarse particle size range may be finer than the second particle size range.

In certain embodiments, the coarse stream may comprise a D50 of about 100 to about 150 microns. In certain embodiments, the fine stream may comprise a D50 of about 20 to about 50 microns. In certain embodiments, the coarse stream may comprise a topcut (D98) of about 120 to about 700 microns. In certain embodiments, the fine stream may comprise a topcut (D98) of about 80 to about 140 microns. In certain embodiments, the coarse stream may comprise a D10 of about 20 to about 50 microns. In certain embodiments, the fine stream may comprise a D10 of about 5 to about 15 microns. In certain further embodiments, one or more of the D50, D98, and/or D10 of the coarse stream may be defined by any suitable sub-range falling within any of the D50, D98, and/or D10 coarse stream ranges noted above, respectively, such as any suitable sub-range bounded at lower and upper ends by any integer values (or values rounded to the nearest tenth of a micron) at or between the upper and lower values noted above. In certain further embodiments, one or more of the D50, D98, and/or D10 of the fine stream may be defined by any suitable sub-range falling within any of the D50, D98, and/or D10 fine stream ranges noted above, respectively, such as any suitable sub-range bounded at lower and upper ends by any integer values (or values rounded to the nearest tenth of a micron) at or between the upper and lower values noted above. In certain embodiments, one or more of the D50, D98, and/or D10 of the coarse stream, the fine stream, or both, may be any suitable integer value (or value rounded to the nearest tenth of a micron) selected from the ranges noted above.

In certain embodiments, the coarse stream may comprise a pulverized glass within a predetermined first particle size range. In certain embodiments, the predetermined first particle size range may be from about 5 microns (lower) to about 800 microns (upper), or any suitable sub-range falling there between, such as a sub-range bounded at lower and upper ends by any integer values (or values rounded to the nearest tenth of a micron) at or between 5 microns and 800 microns.

In certain embodiments, the fine stream may comprise a pulverized glass within a predetermined second particle size range. In certain embodiments, the predetermined second particle size range may be from about 2 microns (lower) to about 200 microns (upper), or any suitable sub-range falling there between, such as a sub-range bounded at lower and upper ends by any integer values (or values rounded to the nearest tenth of a micron) at or between 2 microns and 200 microns.

In certain embodiments, the coarse stream and the fine stream may have one or more properties according to the following:

| | | Lower | Upper | | |
|---|---|---|---|---|---|
| | | (micron) | (micron) | | |
| Coarse | D50 | 100 | 150 | Lower Size | 5 |
| Stream: | D10 | 20 | 50 | (micron): | |
| | Topcut (D98) | 120 | 700 | Upper Size | 800 |
| | | | | (micron): | |
| Fine Stream: | D50 | 20 | 50 | Lower Size | 2 |
| | D10 | 5 | 15 | (micron): | |
| | Topcut (D98) | 80 | 140 | Upper Size | 200 |
| | | | | (micron): | |

As will be understood, the sizing of the coarse stream and/or the fine stream may be selected based on the particular application, the system and/or method configuration being used, and/or the desired properties of the resulting product to be produced. Accordingly, it is contemplated that in certain embodiments the sizing of the coarse stream and/or the fine stream may vary from those described above.

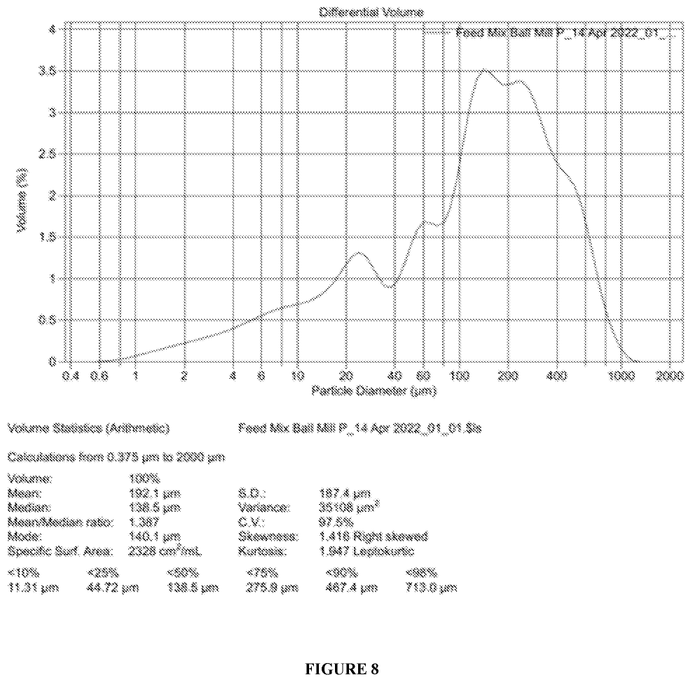

As will be understood, in certain embodiments, at least a portion of the coarse stream and at least a portion of the fine stream may be combined to provide a combined stream for milling. In certain embodiments, because the combined stream is prepared from the coarse stream and the fine stream, the combined stream may be a bi-modal stream in terms of particle size distribution therein (i.e. there may be two size peaks when graphing particle sizes as a probability density function). An example of size distribution of a combined stream comprising the coarse stream and the fine stream is shown in FIG. 8, charting differential volume versus particle diameter chart.

In certain embodiments, the system or process may comprise a mixing unit in communication with the separator configured to receive the coarse stream and configured to receive the fine stream therefrom, the mixing unit configured to combine at least a portion of the coarse stream with at least a portion of the fine stream to provide the combined stream. The mixing unit may include any suitable mixing apparatus known to the person of skill in the art having regard to the teachings herein. By way of example, in an embodiment, mixing unit may comprise an intermediate feed bin, which receives the coarse stream and the fine stream from the separator, and combines the coarse stream and the fine stream therein to provide the combined stream, which may be a substantially heterogeneous mixture of the coarse stream and the fine stream. In another embodiment, it is contemplated that the mixing unit may comprise a feed bin, which receives the coarse stream and the fine stream, and combines the coarse stream and the fine stream therein to provide the combined stream, which may be a substantially heterogeneous mixture of the coarse stream and the fine stream. In another embodiment, it is contemplated that the mixing unit may be a silo, and a feed bin removes the coarse stream and/or fine stream therefrom. While it is contemplated that in certain embodiments the combined stream may be a substantially homogeneous mixture of the coarse stream and the fine stream, the combined stream will more typically be a substantially heterogeneous mixture comprising a plurality of interspersed layers of the coarse stream and layers of the fine stream. The feed bin may be designed to allow for mass flow discharge of the combined stream therefrom to avoid particle size segregation. The ratio of the coarse stream to the fine stream in the combined stream may comprise any suitable ratio, which may be selected to suit the configuration of the mill and/or the desired properties of the glass powder product output therefrom. In certain embodiments, a ratio of the coarse stream to the fine stream in the combined stream may be about 80:20, and the combined stream may be substantially heterogeneous. In certain embodiments, the feed bin may comprise a suitable mass flow bin, where the coarse and fine streams enter the bin at a substantially central position at the top of the feed bin, which may result in formation of microlayers of the coarse and fine streams in the feed bin as the streams are introduced thereto. Controlled withdrawal of the combined stream from the feed bin may result in some blending.

In certain embodiments, a heterogeneous feed stock may be produced and supplied to the mill. In embodiments where separate feed bins are used for the coarse and fine streams, there may be mass ratio selection at the ball mill entrance to control ratio of the coarse and fine streams provided to the mill. In certain embodiments, a 80:20 ratio of coarse stream to fine stream may be used, although it is contemplated that a range of other ratios may be used depending on the particular configuration, and application. For example, in certain embodiments the ratio may be about 40 to about 80 of the coarse stream to about 20 to about 60 of the fine stream, or any suitable sub-ranges or integer values falling therein.

In another embodiment of the systems or processes described herein, the system or process may be configured to provide a feed rate of the coarse stream and the fine stream to the mixing unit (or to the mill, depending on configuration) such that the combined stream (or the feed supplied to the mill) has a ratio of the coarse stream to the fine stream of about 80:20, for example, or another suitable ratio.

In certain embodiments, the combined stream may then be provided to a mill, such as a ball mill, configured for milling the combined stream to provide the glass powder product. Alternatively, in another embodiment, the coarse stream and the fine stream may be combined by inputting the coarse stream into the mill, inputting the fine stream into the mill, and combining the coarse stream and the fine stream in the mill as part of the milling to provide the glass powder product.

By way of example, in certain embodiments, the system or process may comprise a first feed bin in communication with the separator and configured to receive the coarse stream therefrom, and a second feed bin in communication with the separator and configured to receive the fine stream therefrom, the first and second feed bins for supplying respectively the coarse stream and the fine stream to the mill for milling.

In certain embodiments, the mill will be supplied with at least some of the coarse stream, and at least some of the fine stream. Milling may cause mixing of the first stream and the fine stream, and provide the glass powder product. Such configuration may allow for control over ratios of the first and fine streams input to the mill. In certain embodiments, it is contemplated that the mill may be supplied with only the coarse stream.

As will be understood, the mill may comprise any suitable milling unit as will be known to the person of skill in the art having regard to the teachings herein. In certain embodiments, the mill may comprise a ball or media mill, although other mills such as a jet mill are also contemplated in certain embodiments. Typically, the mill will comprise a ball or media mill. In certain embodiments, the mill may comprise, for example, a ball mill. The mill may be configured to provide the glass powder product to a particular specification desired for the particular application. For example, the ball size, ball load, ball porosity, mill speed, mill liner type, and/or mill L/D ratio of the ball mill may be adjusted to provide the glass powder product output therefrom with a desired particle size profile. In yet another embodiment, the mill may comprise a ball mill with a charge porosity configured for production of ultra-fines. In yet another embodiment, the mill may comprise a ball mill with a charge porosity configured for production of fines. In still another embodiment, the fine stream may be milled in a ball mill prior to combining with the coarse stream. In certain embodiments, the ball mill may comprise a ceramic-lined ball mill with ceramic media of moderate porosity, for example.

In still another embodiment, the system or process may be configured with two ball mills. In such configuration, the coarse stream may be supplied to a first ball mill, which performs milling to generate a fine stream, which may be sent with the coarse stream to a second ball mill configured for ultra-fine processing for further milling to provide an ultra-fine glass powder product. In another embodiment, the coarse stream and fine stream may be supplied to a first ball mill, which performs milling to generate an intermediate glass powder product, which may be sent to a second ball mill configured for ultra-fine processing for further milling to provide an ultra-fine glass powder product. In still another embodiment, the second mill may be configured to receive the fine stream from the separator and to mill the fine stream prior to combining the fine stream with the coarse stream at the mixing unit. In an embodiment, the second mill may comprise a ball mill.

In certain embodiments of the systems or processes described herein, the systems may be dry or waterless, and may be configured without an input for water or liquid. Whereas traditionally glass treatment systems have commonly employed a washing unit or other wet or liquid treatment apparatus, further triggering a need for resource-intensive water removal equipment, systems described herein may be configured without such exposure of the glass to liquid. Accordingly, a water removal apparatus may be omitted, or may be operated for less time and/or at lower temperature, since wetting of the glass may be avoided in the embodiments described herein.

In another embodiment, the system or process may further comprise a crusher configured to receive a waste glass input feed, to crush the waste glass input feed to provide a crushed waste glass, and to provide the crushed waste glass to the crushed waste glass input. In certain embodiments, the separator may be in communication with the crusher, or with another crusher, and may be configured to transfer at least a portion of the primary stream to the crusher to generate additional crushed glass waste for repeating the process. In certain embodiments, the crusher may comprise a vertical impact crusher (such as a vertical impact glass crusher available from Remco, American Pulverizer, etc. . . . ), or another type of crusher such as a roller crusher (i.e. single and/or double), or a jaw crusher (i.e. a Pennsylvania type crusher), for example.

Accordingly, in certain embodiments, systems and processes described herein may be configured to include a recirculation loop, whereby the primary and/or the reject stream is crushed at the crusher, and returned to the separator for separation to produce additional coarse stream and/or fine stream. In certain embodiments, the primary and/or the reject stream may be crushed at the crusher and then mixed in with crushed waste glass being directed to the separator. In certain embodiments, the primary and/or the reject stream may be mixed with incoming waste glass input feed, and the primary and/or the reject stream and incoming waste glass input feed may be crushed at the crusher to provide the crushed waste glass being sorted at the separator.

In another embodiment, the systems and processes described herein may further comprise an Eddy separator in communication with the separator and configured to receive the primary stream and/or the reject stream from the separator and to treat the primary stream and/or reject stream to remove aluminum or other non-ferrous metals and/or residual plastic therefrom, the Eddy separator further in communication with the crusher for transferring the primary stream and/or reject stream to the crusher following treatment. In certain embodiments, the system or process may further comprise a pre-screen configured to remove large contaminants from the primary stream and/or reject stream prior to the primary stream and/or reject stream entering the Eddy separator. As will be understood, any suitable Eddy separator unit known to the person of skill in the art having regard to the teachings herein may be used. Examples of Eddy current separators may include those available from Green Machine, Vibrotech, Master Magnets, Goudsmit, or others.

In certain embodiments of the systems or processes described herein, the separator may comprise a screener (such as a vibratory screener) for screening the primary stream. In another embodiment, the screener may comprise at least one screen for separating the primary stream into the coarse stream and the fine stream. In still another embodiment, the screener may be a multi-deck screener comprising an upstream deck with a coarse mesh screen outputting the coarse stream and a downstream deck with a fine mesh screen outputting the fine stream. In certain embodiments, the fine mesh screen of the downstream deck may have a mesh size of about 70 to about 100 mesh, or higher. In still another embodiment, the system or process may be configured such that materials, which pass through the coarse mesh screen but which do not pass through the fine mesh screen may be output as a reject stream. In yet another embodiment, the multi-deck screener may further comprise one or more intermediate decks each with an intermediate mesh screen, for outputting one or more reject streams each having a different particle size range. In yet another embodiment, the one or more intermediate decks may be for outputting two or more reject streams, each having a different particle size range. In still another embodiment, the multi-deck screener may comprise 1 to 3 sequentially arranged intermediate decks of progressively finer mesh size, the intermediate decks arranged downstream of the upstream deck and upstream of the downstream deck. In still another embodiment, wherein the screens of the multi-deck screener may become progressively finer moving through the multi-deck screener.

In certain embodiments, the separator may be configured to output at least one reject stream for use in generating another glass-based product, such as a glass-based product which does not require ultra-fine grade particles, such as a sand blasting abrasive product, another abrasive product, a product for glass counter-top production, or a glass-based product for coatings, aquarium glass, or other such uses, for example.

In still another embodiment of the systems or processes described herein, the system or process may further comprise an air classifier in communication with the mill and configured to receive at least a portion of the glass powder product therefrom and to sort the glass powder product to provide a glass powder product stream within a predetermined particle size range, and a reject glass powder product stream comprising glass powder excluded from the glass powder product stream.

The predetermined particle size range may be defined by an upper end size cut-off, or may be defined by an upper end size cut-off and a lower end size cut-off, which may be implemented by configuring settings of the air classifier accordingly. The predetermined particle size range may be selected to suit the particular application, such that the glass powder product stream comprises pulverized glass particles each having a particle size which is below an upper threshold size and optionally above a lower threshold size, and having a population mean particle size within the predetermined particle size range. The glass powder product stream may comprise pulverized glass particles, with a particle size distribution having an upper size cut-off corresponding with the upper threshold size, and optionally having a lower size cut-off corresponding with the lower threshold size. In certain embodiments, the glass powder product stream may comprise a glass powder product having a particular particle size distribution. In certain embodiments, the glass powder product may comprise a generally leptokurtic particle size distribution. In certain embodiments, the glass powder product stream may comprise ultra-fine glass powder product. Examples of glass powder products are described in further detail below.

In still another embodiment, the system or process may be configured to provide the recycled-glass powder pozzolan product and/or glass powder product stream comprising an ultra-fine glass powder product having a leptokurtic particle size curve.

In certain embodiments, the recycled-glass powder pozzolan product may have one or more properties according to the following:

| | | Lower | Upper | | |
|---|---|---|---|---|---|
| | | (micron) | (micron) | | |
| Glass | D50 | 2 | 7 | Lower Size | 0.5 |
| Powder | D10 | 0.7 | 2 | (micron) | |
| Product: | Topcut (D98) | 6 | 20 | Upper Size | 30 |
| | Mean | 2.5 | 6 | (micron) | |

In certain embodiments, the recycled-glass powder pozzolan product may comprise a glass powder product having one or more of: a brightness L* (CIE) of about 90% or greater; an loss of ignition (LOI) of about 0.5% or less; a moisture of about 0.5% or less; or any combination thereof. Brightness may be determined on a spectrophotometer, any equivalent method or combination thereof, with D65 illuminant and 100 observer conditions. Loss of ignition may be determined by CSA A3003-13 at 600° C., any equivalent method or combination thereof. In certain embodiments, the glass powder product may have a substantially leptokurtic particle size distribution.

In certain embodiments, the glass powder pozzolan product may have comprise one or more of a particle size range based on mean of about 2.5 to about 6 microns; a specific surface area range of about 16000 to about 27000 cm2/mL; a particle size D10 of about 0.7 microns to about 2 microns; a particle size D98 of about 6 microns to about 20 microns; a particle size D50 of about 2 to about 7 microns; a refractive index of about 1.5; a round or angular particle shape; a micro-crystalline silica content of about 0; or any combination thereof.

In still another embodiment, the air classifier may be in communication with the mixing unit (or the feed bin(s)) and/or the mill, and may be configured to return the reject glass powder product stream back to the mill either alone or mixed with the coarse stream, the fine stream, or both, or a combined stream comprising the coarse stream and the fine stream, for further milling to generate additional glass powder product. In certain embodiments, a ratio of the reject glass powder product stream to the combined stream may be adjusted based on the particular application to provide suitable glass powder pozzolan product.

Accordingly, in certain embodiments, systems and processes described herein may include a recirculation loop, whereby the reject glass powder product stream is returned to the mill to produce additional glass powder product stream. In certain embodiments, the reject glass powder product stream may be milled, or may be mixed with additional combined stream, coarse stream, or fine stream, or both, and milled. In certain embodiments, ratio of the combined stream, the coarse stream, or the fine stream to the reject glass powder product stream provided to the mill may be adjusted to provide a desired glass powder product output.

In yet another embodiment, the air classifier may be configured to recover ultra-fine glass powder product based on material mass to air mass ratio within the air classifier, thereby providing an ultra-fine glass powder product having a target leptokurtic particle size curve as the glass powder product stream. By way of example, classifier speed (RPM), fan flow rate, and/or internal mechanical modifications (i.e. spacing of classifier vanes) may be adjusted to provide a target particle size distribution of the glass powder product stream output from the air classifier.

In still another embodiment of the systems or processes described herein, the glass powder product, or the glass powder product stream, may comprise a particle size D50 range from about 7 microns to about 2 microns.

In certain embodiments, particle size analysis may be determined on a single wavelength laser particle size distribution apparatus, any equivalent method or combination thereof. Herein, as would be appreciated by a person of skill, the portion of particles with diameters smaller and larger than this value is 50% is referred to as D50, the portion of particles with diameters smaller than this value is 10% is referred to as D10, and the portion of particles with diameters smaller than this value is 98% is referred to as D98 or topcut.

In another embodiment of the systems or processes described herein, the system or process may be configured to allow adjustment of the ratio of the coarse stream to the fine stream to be milled so as to provide the glass powder product as an ultra-fine glass powder product having a target leptokurtic particle size distribution, for example.

In certain embodiments of the systems or processes described herein, wherein at least a portion of the crushed waste glass or the waste glass input feed is generated from a post-consumer waste glass, the system or process may further comprise at least one of an initial crusher for crushing the post-consumer waste glass, a high-temperature dryer configured to destroy paper, light plastic, and organic contaminants contained in the post-consumer waste glass, and a magnet for removing ferrous metal contaminants from the post-consumer waste glass. The initial crusher, high-temperature dryer and magnet being arranged along a path followed by the post-consumer waste glass, the path leading to the crushed waste glass input.

In certain embodiments, the system or process may comprise a crusher configured to receive a waste glass input feed, wherein the crusher may be the crusher described above or a different crusher, to crush the waste glass input feed to provide a crushed waste glass, and to provide the crushed waste glass to the crushed waste glass input. In certain embodiments, the path may lead the post-consumer waste glass to the crusher, the post-consumer waste glass providing at least a portion of the waste glass input feed for the crusher, for example. In yet another embodiment, at least one vertical impact crusher may be used for crushing to provide the crushed waste glass.

In still another embodiment, the high temperature dryer may be in communication with the crusher, or with the crushed waste glass input, through a fluidized bed cooler configured along the path to cool the post-consumer waste glass. In certain embodiments, the high-temperature dryer may comprise a rotary kiln dryer. In certain embodiments, the high-temperature dryer may comprise a tumbler dryer.

In still another embodiment of the systems or processes described herein, the magnet may be configured with a conveyor belt for removing ferrous metal contaminants from the post-consumer waste glass during transfer thereof, or may be configured in proximity with the post-consumer waste glass in another manner as will be known to the skilled person having regard to the teachings herein such that ferrous contaminants may be removed by the magnet.

In certain embodiments, the crushed waste glass may comprise glass from post-consumer waste glass which has been color-sorted. In certain embodiments, the crushed waste glass may comprise a green glass, producing a green glass powder product, in an amount of 75% of the coarse glass stream, with the remaining 25% being a combination of white, amber and blue glass. In yet another embodiment of the systems described herein, the mixed glass powder product may comprise a brightness level at or exceeding 90 L on a standardized CIE scale (D65/10 observant). In certain embodiments, the crushed waste glass may comprise clear glass, and may be substantially free of colored glass, producing a white glass powder product. In yet another embodiment, the clear glass powder product may comprise a brightness level at or exceeding 95 L on a standardized CIE scale (D65/10 observant).

In still another embodiment, the systems or processes described herein may further comprise an input for adding an anti-static grinding aid to the coarse stream, the fine stream, or both, or to a combined stream comprising the coarse stream and the fine stream, prior to milling. As will be understood, the grinding aid may comprise any suitable anti-static grinding aid material, serving to dissipate charge accumulation on the glass particles. In certain embodiments, the anti-static grinding aid may be added via a pump controlled by feed rate to the mill, so that dosage may be kept substantially constant. Grinding aids, and water-diluted versions thereof, may be commercially obtained from various sources. In certain embodiments, a grinding aid may include a grinding aid commercially available from WR Grace (i.e. HEA2, MTDA), Chryso, or ProDexim, for example.

In still another embodiment, there is provided herein a system or process for preparing a glass powder pozzolan product from a waste glass input feed, the system comprising:
a crusher configured to crush the waste glass input feed to provide a crushed waste glass, and to provide the crushed waste glass to a crushed waste glass input;
a mill configured to receive the coarse stream comprising a pulverized glass within a predetermined first particle size range and the fine stream within a predetermined second particle size range, either separately or as a combined stream, and to mill the coarse stream and the combined stream to provide the glass powder pozzolan product.

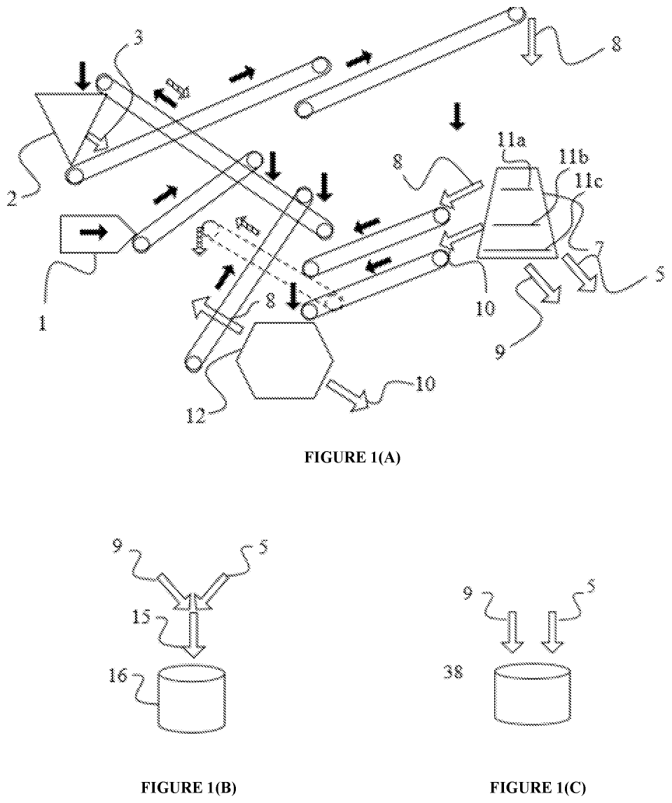

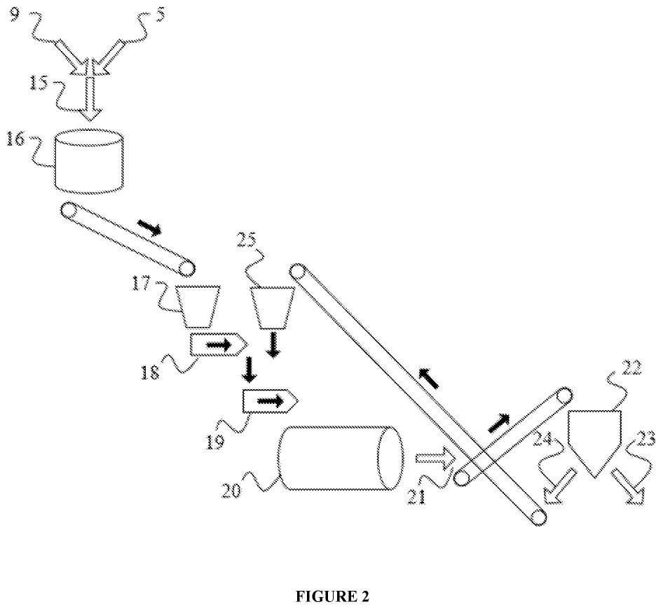

An example of a system for preparing a glass powder product as described herein is depicted in FIGS. 1, 2 and 5. With reference to FIGS. 1(A), 1(B), and 2, the depicted system example comprises:
a crushed waste glass input (3), the crushed waste glass input (3) configured to receive crushed waste glass from a vertical impact crusher (2), the vertical impact crusher (2) configured to receive a waste glass input feed (1) and to crush the waste glass input feed (1) to generate the crushed waste glass supplied to the crushed waste glass input (3);
a mixing unit (16) in communication with the separator (7) and configured to receive the coarse stream (5) and configured to receive the fine stream (9) therefrom, the mixing unit (16) for combining at least a portion of the coarse stream (5) and at least a portion of the fine stream (9) to provide a combined stream (15) therein; and
a mill (20) configured to receive the combined stream (15) (in this example, via a belt, feed hopper (17), and feed screws (18) and (19)) and to mill the combined stream (15) to provide the glass powder product (21).

In the depicted system example, the separator (7) is configured such that the predetermined coarse particle size range and the predetermined fine particle size range are different, and partially overlapping. Typically, the coarse end of fine stream may overlap with fine end of coarse stream. In the depicted embodiment, the coarse stream (5) comprises a D50 range of about 100 to about 150 microns, and the fine stream (9) comprises a D50 range of about 20 to about 50 microns.

As shown, the depicted system is a dry system, which does not input water or liquid.

In the depicted system, the separator (7) is in communication with the crusher (2), and configured to transfer at least a portion of the primary stream (8) to the crusher (2) to generate additional crushed glass waste. The primary stream (8) is added to the crusher (2) along with waste glass input feed (1), thus generating additional crushed waste glass which is provided to the crushed waste glass input (3). In the depicted example, the primary stream (8) is conveyed by a series of belts, optionally through an Eddy separator (12) as described below, to a main feed belt which is also used to covey the waste glass input feed (1) to the crusher (2).

As shown in FIG. 1(A), the system further comprises an Eddy separator (12) in communication with the separator (7), and configured to receive the primary stream (8) from the separator (7) and to treat the primary stream (8) to remove aluminum or other non-ferrous metals and/or residual plastic therefrom, the Eddy separator (12) further in communication with the crusher (2) for transferring the primary stream (8) to the crusher (2) following treatment therein as described above. Although not shown, the system may further comprise a pre-screen configured to remove large contaminants from the primary stream prior to the primary stream entering the Eddy separator. Where the Eddy separator (12) is not used, or where it is desirable for the primary stream (8) or a portion thereof to bypass the Eddy separator (12), an optional bypass belt may be provided, as shown in dashed lines, for allowing the primary stream (8), and/or reject stream (10) as described below, to bypass the Eddy separator (12) and proceed to the main feed belt which is also used to convey the waste glass input feed (1) to the crusher (2).

In the depicted example, the main belt, which transfers at least the primary stream to the crusher (2) is configured to periodically reverse direction to clear accumulated large non-glass waste into a trash stream.

In the depicted system example, the separator (7) comprises a multi-deck screener having an upstream deck (11a) with a course mesh screen, and a downstream deck (11c) having a fine mesh screen. The upstream deck (11a) outputs materials retained thereon (i.e. materials too large to pass through the coarse mesh screen) as the coarse stream (8), and the downstream deck (11c) outputs materials passing therethrough (i.e. materials small enough to pass through the fine mesh screen) as the fine stream (9). In the depicted example, the fine mesh screen has a mesh size of about 70 to about 100 mesh.

As shown in FIG. 1(A), the system is configured such that materials, which pass through the coarse mesh screen but which do not pass through the fine mesh screen are output as a reject stream (10). The multi-deck screener further comprises one or more intermediate decks (11b), each with an intermediate mesh screen, configured for outputting one or more reject streams. Thus, in the depicted embodiment, two reject streams (10) are output, one comprising materials too large to pass through the intermediate deck (11b) screen, and the other comprising materials small enough to pass through the intermediate deck (11b) but too large to pass through the fine mesh screen of the downstream deck (11c). The reject streams may be obtained separately and used for different applications, or may be recovered together with the intermediate deck (11b) being provided for increasing throughput by preventing clogging of the screen of the downstream deck (11c). As will be understood, the screens of the separator (7) become progressively finer moving through the multi-deck screener.

In the depicted system shown in FIG. 1(A), the two reject streams are combined as reject stream (10), and the system is configured to transfer reject stream (10) to the crusher (2) to generate additional crushed waste glass. The reject stream (10) is added to the crusher (2) along with primary stream (8) and/or waste glass input feed (1) to generate additional crushed waste glass. As shown, the reject stream (10) of the depicted system is also provided to the Eddy separator (12) en route to the crusher (2). The Eddy separator (12) is in communication with the separator (7), and configured to receive the reject stream (10) therefrom in addition to receiving the primary stream (8) therefrom, and to remove aluminum or other non-ferrous metals and/or residual plastic. The primary stream (8) and the reject stream (10) are then transferred from the Eddy separator (12) to the crusher (2) following treatment therein. Although not shown, the system may further comprise a pre-screen configured to remove large contaminants from the reject stream prior to the reject stream entering the Eddy separator, which may or may not be the same pre-screen which may be provided in communication with the primary stream.

Accordingly, in the system depicted in FIG. 1(A), there is a re-circulation loop in which certain materials from the waste glass input feed (1) which are not recovered in the coarse stream (5) and the fine stream (9) are circulated back, optionally via an Eddy separator (12), to the crusher (2) and then through the cycle again.

As shown in FIG. 1(B) and FIG. 2, a mixing unit (16) is in communication with the separator (7) and configured to receive the coarse stream (5) and the fine stream (9) therefrom, the mixing unit (16) for combining at least a portion of the coarse stream (5) and at least a portion of the fine stream (9) to provide a bi-modal combined stream (15) therein. In the depicted embodiment, the mixing unit (16) comprises an intermediate feed bin. The mixing unit (16) is configured to allow for adjustment of the ratio of the coarse stream (5) to the fine stream (9) making up the combined stream (15), by adjusting feed rates of the coarse stream and the fine stream to the mixing unit (16), or otherwise controlling the ratio thereof in the combined stream (15). In the depicted system, the mixing unit (16) is configured to provide the combined stream (15) having a ratio of the coarse stream to the fine stream of about 80:20, the combined stream (15) being substantially homogenously mixed.

As shown in FIG. 2, the depicted system comprises a mill (20) configured to receive the combined stream (15) (in this example, via a belt, feed hopper (17), and feed screws (18) and (19)) and to mill the combined stream (15) to provide the glass powder product (21), the glass powder product (21) comprising an ultra-fine glass powder product having a target size range and a target generally leptokurtic particle size distribution. The depicted mill (20) is a ball mill with a charge porosity configured for production of ultra-fines.

As shown in FIG. 2, the depicted system example further comprises an air classifier (22) in communication with the mill (20) via a belt and configured to receive at least a portion of the glass powder product (21) therefrom and to sort the glass powder product (21) to provide a glass powder product stream (23) within a predetermined particle size range, and a reject glass powder product stream (24) comprising glass powder excluded from the glass powder product stream (23). The air classifier (22) may be in communication with the mixing unit (16) and/or the mill (20), and may configured to return the reject glass powder product stream (24) back to the mill (20) either alone or mixed with the combined stream (15) for further milling to generate additional glass powder pozzolan product (21) or glass powder product stream (23). In the depicted embodiment, the air classifier (22) is in communication with a second feed hopper (25), which supplies feed screw (19) which also carries combined stream (15) to the mill (20). In such manner, ratio of the combined stream to the reject glass powder product stream entering the mill may be adjusted.

Thus, in the depicted embodiment, the system comprises a second recirculation loop, whereby reject glass powder product stream (24) is recirculated through the mill (20) to generate additional glass powder pozzolan product (21) and/or glass powder pozzolan product stream (23).

In the depicted system, the air classifier (22) is configured to recover ultra-fine glass powder product based on material mass to air mass ratio within the air classifier (22), thereby providing an ultra-fine glass powder product having a leptokurtic particle size curve as the glass powder product stream (23).

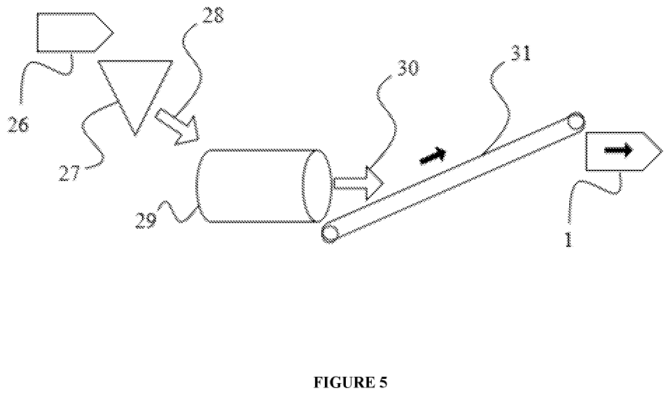

In the depicted system embodiment, at least a portion of the crushed waste glass at the crushed waste glass input (3), or the waste glass input feed (1), is generated from post-consumer waste glass. As shown in FIG. 5, the waste glass input feed (1) is generated from a post-consumer waste glass (26). The depicted system further comprises an initial crusher (27) for crushing the post-consumer waste glass (26) (in this example, the crusher produces a crushed soda-lime glass feed with a size of about ½ inch or less); a high temperature rotary-kiln dryer (29) for destroying paper, light plastic, and organic contaminants contained in the post-consumer waste glass (in this example, the dryer air temperature is between about 400 and about 600° C. (material discharge temperature of about 250 C to about 300 C); and a magnet for removing ferrous metal contaminants from the post-consumer waste glass (arranged along conveyor belt (31)), which are arranged in sequence along a path followed by the post-consumer waste glass, the path leading to the crushed waste glass input (3), optionally via crusher (2). Although not shown, the high temperature dryer (29) of the depicted system is in communication with the crusher (2) through a fluidized bed cooler configured along the path to cool the post-consumer waste glass to a temperature of about 25-40° C.

Although not shown, the depicted system may further comprise a second mill, such as a ball mill, configured to receive the fine stream (9) from the separator (7) and to mill the fine stream (9) prior to combining with the coarse stream (5) at the mixing unit (16).

Although not shown, in certain embodiments the depicted system may further comprise another mill, such as a ball mill, configured to receive the glass powder product from a first mill, and further process the glass powder product to provide an ultra-fine glass powder product.

Produced glass powder pozzolan product stream (23) may then be directed to product silos for packaging and shipment, for example.

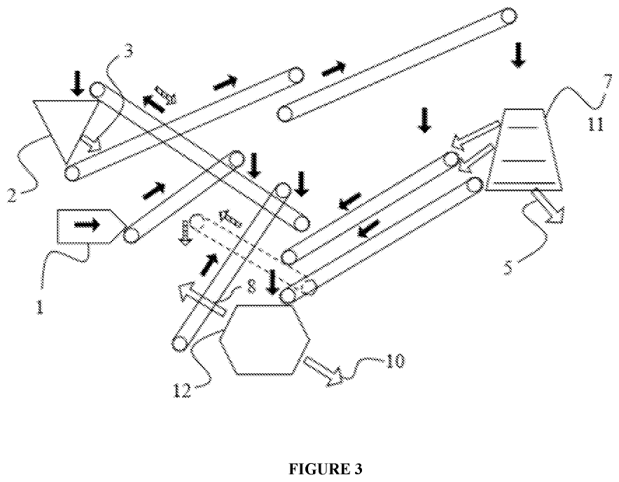

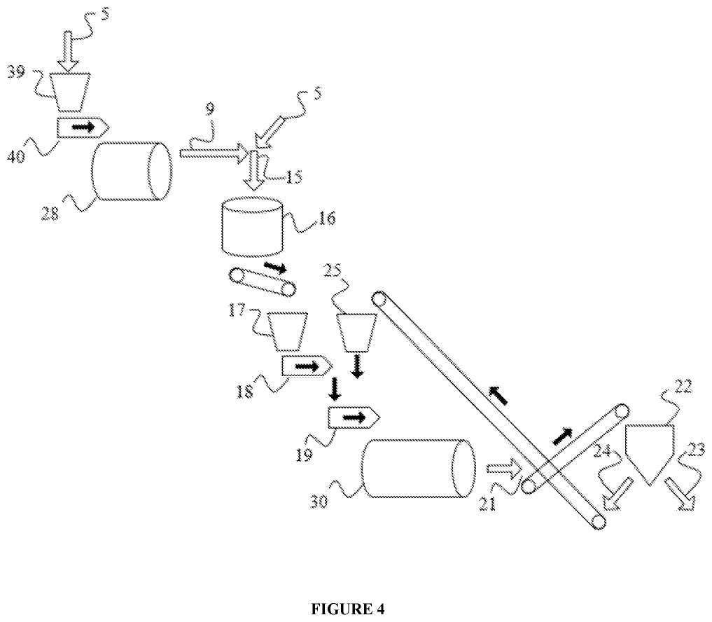

An example of a system for preparing a glass powder product as described herein is depicted in FIGS. 3-5. With reference to FIGS. 3 and 4, the depicted system example comprises:
a crushed waste glass input (3), the crushed waste glass input (3) configured to receive crushed waste glass from a vertical impact crusher (2), the vertical impact crusher (2) configured to receive a waste glass input feed (1) and to crush the waste glass input feed (1) to generate the crushed waste glass supplied to the crushed waste glass input (3);
a first mill (28) configured to receive a coarse stream (9) (in this example, via a feed hopper (39), and feed screw (40)) and to mill the coarse stream (9) to provide the fine stream (5).
a mixing unit (16) configured to receive the coarse stream (5) from the separator (7), and configured to receive the fine stream (9) from the first mill (28), the mixing unit (16) for combining at least a portion of the coarse stream (5) and at least a portion of the fine stream (9) to provide a combined stream (15) therein; and
a second mill (30) configured to receive the combined stream (15) (in this example, via a belt, feed hopper (17), and feed screws (18) and (19)) and to mill the combined stream (15) to provide the glass powder product (21).

In the depicted system example, separator (7) is configured such that the predetermined coarse particle size range of the coarse stream (5) comprises a D50 range of about 100 to about 150 microns, and first mill (28) is configured such that the predetermined fine particle size range of the fine stream (9) comprises a D50 range of about 20 to about 50 microns.

As shown, the depicted system is a dry system, which does not input water or liquid.

In the depicted system, the separator (7) is in communication with the crusher (2), and configured to transfer at least a portion of the primary stream (8) to the crusher (2) to generate additional crushed glass waste. The primary stream (8) is added to the crusher (2) along with waste glass input feed (1), thus generating additional crushed waste glass which is provided to the crushed waste glass input (3). In the depicted example, the primary stream (8) is conveyed by a series of belts, optionally through an Eddy separator (12) as described below, to a main feed belt which is also used to covey the waste glass input feed (1) to the crusher (2).

As shown in FIG. 3, the system further comprises an Eddy separator (12) in communication with the separator (7), and configured to receive the primary stream (8) from the separator (7) and to treat the primary stream (8) to remove aluminum or other non-ferrous metals and/or residual plastic therefrom, the Eddy separator (12) further in communication with the crusher (2) for transferring the primary stream (8) to the crusher (2) following treatment therein as described above. Although not shown, the system may further comprise a pre-screen configured to remove large contaminants from the primary stream prior to the primary stream entering the Eddy separator. Where the Eddy separator (12) is not used, or where it is desirable for the primary stream (8) or a portion thereof to bypass the Eddy separator (12), an optional bypass belt may be provided, as shown in dashed lines, for allowing the primary stream (8), and/or reject stream (10) as described below, to bypass the Eddy separator (12) and proceed to the main feed belt which is also used to covey the waste glass input feed (1) to the crusher (2).

In the depicted example, the main belt which transfers at least the primary stream to the crusher (2) is configured to periodically reverse direction to clear accumulated large non-glass waste into a trash stream.

In the depicted system example, the separator (7) comprises a screener having an upstream deck (11a) with a course mesh screen, and a downstream deck (11c) having a fine mesh screen. The upstream deck (11a) outputs materials retained thereon (i.e. materials too large to pass through the coarse mesh screen) as the coarse stream (8), and the downstream deck (11c) outputs materials passing therethrough (i.e. materials small enough to pass through the fine mesh screen) as the fine stream (9). In the depicted example, the fine mesh screen has a mesh size of about 70 to about 100 mesh.

As shown in FIG. 3, the system is configured such that materials which pass through the coarse mesh screen but which do not pass through the fine mesh screen are output as a reject stream (10). The screener may further comprises one or more intermediate decks (11b), each with an intermediate mesh screen, configured for outputting one or more reject streams. Thus, in the depicted embodiment, two reject streams (10) are output, one comprising materials too large to pass through the intermediate deck (11b) screen, and the other comprising materials small enough to pass through the intermediate deck (11b) but too large to pass through the fine mesh screen of the downstream deck (11c). The reject streams may be obtained separately and used for different applications, or may be recovered together with the intermediate deck (11b) being provided for increasing throughput by preventing clogging of the screen of the downstream deck (11c). As will be understood, the screens of the separator (7) become progressively finer moving through the multi-deck screener.

In the depicted system shown in FIG. 3, the two reject streams are combined as reject stream (10), and the system is configured to transfer reject stream (10) to the crusher (2) to generate additional crushed waste glass. The reject stream (10) is added to the crusher (2) along with primary stream (8) and/or waste glass input feed (1) to generate additional crushed waste glass. As shown, the reject stream (10) of the depicted system is also provided to the Eddy separator (12) en route to the crusher (2). The Eddy separator (12) is in communication with the separator (7), and configured to receive the reject stream (10) therefrom in addition to receiving the primary stream (8) therefrom, and to remove aluminum or other non-ferrous metals and/or residual plastic. The primary stream (8) and the reject stream (10) are then transferred from the Eddy separator (12) to the crusher (2) following treatment therein. Although not shown, the system may further comprise a pre-screen configured to remove large contaminants from the reject stream prior to the reject stream entering the Eddy separator, which may or may not be the same pre-screen, which may be provided in communication with the primary stream.

Accordingly, in the system depicted in FIG. 3, there is a re-circulation loop in which certain materials from the waste glass input feed (1) which are not recovered in the coarse stream (5) are circulated back, optionally via an Eddy separator (12), to the crusher (2) and then through the cycle again.

As shown in FIG. 4, a mixing unit (16) is configured to receive the fine stream (9) and the coarse stream (5), the mixing unit (16) for combining at least a portion of the coarse stream (5) and at least a portion of the fine stream (9) to provide a bi-modal combined stream (15) therein. The mixing unit (16) is configured to allow for adjustment of the ratio of the coarse stream (5) to the fine stream (9) making up the combined stream (15), by adjusting feed rates of the coarse stream and the fine stream to the mixing unit (16), or otherwise controlling the ratio thereof in the combined stream (15). In the depicted system, the mixing unit (16) is configured to provide the combined stream (15) having a ratio of the coarse stream to the fine stream of about 80:20, the combined stream (15) being substantially homogenously mixed.

As shown in FIG. 4, the depicted system comprises a first mill (28) configured to receive the coarse stream (5) (in this example, via a feed hopper (39), and feed screw (40)) and to mill the coarse stream (5) to provide a fine stream (9). A second mill (30) is configured to receive the coarse stream (5) and fine stream (9) (in this example, via a belt, feed hopper (17), and feed screws (18) and (19)) and to mill the coarse stream (5) and the fine stream (9) to provide the glass powder product (21). The glass powder product (21) comprising an ultra-fine glass powder product having a target size range and a target generally leptokurtic particle size distribution. The depicted first mill (28) is a ball mill with a charge porosity configured for production of fines and the depicted second mill (30) is a ball mill with a charge porosity configured for production of ultra-fines.

As shown in FIG. 4, the depicted system example further comprises an air classifier (22) in communication with the second mill (30) via a belt and configured to receive at least a portion of the glass powder product (21) therefrom and to sort the glass powder product (21) to provide a glass powder product stream (23) within a predetermined particle size range, and a reject glass powder product stream (24) comprising glass powder excluded from the glass powder product stream (23). The air classifier (22) may be in communication with the mixing unit (16) and/or the mill (30), and may configured to return the reject glass powder product stream (24) back to the mill (30) either alone or mixed with the combined stream (15) for further milling to generate additional glass powder pozzolan product (21) or glass powder product stream (23). In the depicted embodiment, the air classifier (22) is in communication with a second feed hopper (25), which supplies feed screw (19) which also carries combined stream (15) to the mill (30). In such manner, ratio of the combined stream to the reject glass powder product stream entering the mill may be adjusted.

Thus, in the depicted embodiment, the system comprises a second recirculation loop, whereby reject glass powder product stream (24) is recirculated through the mill (30) to generate additional glass powder pozzolan product (21) and/or glass powder pozzolan product stream (23).

In the depicted system, the air classifier (22) is configured to recover ultra-fine glass powder product based on material mass to air mass ratio within the air classifier (22), thereby providing an ultra-fine glass powder product having a leptokurtic particle size curve as the glass powder product stream (23).

In the depicted system embodiment, at least a portion of the crushed waste glass at the crushed waste glass input (3), or the waste glass input feed (1), is generated from post-consumer waste glass. As shown in FIG. 5, the waste glass input feed (1) is generated from a post-consumer waste glass (26). The depicted system further comprises an initial crusher (27) for crushing the post-consumer waste glass (26) (in this example, the crusher produces a crushed soda-lime glass feed with a size of about ½ inch or less); a high temperature rotary-kiln dryer (29) for destroying paper, light plastic, and organic contaminants contained in the post-consumer waste glass (in this example, the dryer air temperature is between about 400 and about 600° C. (material discharge temperature of about 250 C to about 300 C); and a magnet for removing ferrous metal contaminants from the post-consumer waste glass (arranged along conveyor belt (31)), which are arranged in sequence along a path followed by the post-consumer waste glass, the path leading to the crushed waste glass input (3), optionally via crusher (2). Although not shown, the high temperature dryer (29) of the depicted system is in communication with the crusher (2) through a fluidized bed cooler configured along the path to cool the post-consumer waste glass to a temperature of about 25-40° C.

In certain embodiments herein, the ball mill internals and other critical wear areas of the depicted system may be ceramic lined with white alumina-based ceramic to avoid product discoloration, where high product brightness and/or whiteness is desired.

As well, although not shown, in certain embodiments herein, the depicted systems may further comprise an input for adding an anti-static grinding aid to the combined stream (15) prior to milling at mill (20); and/or may comprise one or more antistatic air jets configured to remove static from the glass powder product (21) or glass powder product stream (23) being produced.

Produced glass powder pozzolan product stream (23) may then be directed to product silos for packaging and shipment, for example.

As will also be understood, in certain embodiments, it is contemplated that the separator configuration depicted in FIG. 1 or FIG. 3 may alternatively be configured with a single separator unit (i.e. a vibratory screener, for example). Accordingly, in certain embodiments, there is provided herein a system or process for preparing a glass powder product, the system or process comprising a crushed waste glass input, a separator in communication with the crushed waste glass input and configured to receive a crushed waste glass therefrom and sort the crushed waste glass to provide a coarse stream comprising a pulverized glass within a predetermined first particle size range, a mill configured to receive at least a portion of the coarse stream, and to mill the coarse stream to provide a fine stream having a predetermined second particle size range; and a mill configured to receive at least a portion of the coarse stream and at least a portion of the fine stream, or a mixture thereof, and to mill the coarse stream and the fine stream to provide the glass powder product.

In another embodiment, the system or process comprising a crushed waste glass input, a separator in communication with the crushed waste glass input and configured to receive a crushed waste glass therefrom and sort the crushed waste glass to provide a coarse stream comprising a pulverized glass within a predetermined first particle size range, and a fine stream having a predetermined second particle size range; and a mill configured to receive at least a portion of the coarse stream and at least a portion of the fine stream, or a mixture thereof, and to mill the coarse stream and the fine stream to provide the glass powder product.

An example of such a system is depicted in FIGS. 1-4, in which the depicted system further comprises:
a crushed waste glass input (3), the crushed waste glass input (3) configured to receive crushed waste glass from a vertical impact crusher (2), the vertical impact crusher (2) configured to receive a waste glass input feed (1) and to crush the waste glass input feed (1) to generate the crushed waste glass supplied to the crushed waste glass input (3);
a separator (7) in communication with the crushed waste glass input (3) via one or more belts, and configured to receive a crushed waste glass therefrom and sort the crushed waste glass to provide a coarse stream (5) (in this example, from below a lower screen deck of the separator), the coarse stream (5) comprising a pulverized glass within a predetermined first particle size range, and a fine stream (9) (in this example, from above the lower screen deck), the fine stream (9) having a predetermined second particle size range;
a feed bin (38) in communication with the separator (7) and configured to receive the coarse stream (5) and to receive the fine stream (9) therefrom; and
a mill (20) configured to receive the coarse stream (5) and the fine stream (9) from the feed bin (38), and to mill the received coarse stream and fine stream, to provide the glass powder product (21).

In certain embodiments, the system above is configured with two ball mills as described herein.

In the depicted embodiment, the separator (7) is a multi-deck vibratory screener, which also outputs other reject glass powder streams depicted to the left of separator (7), which may be recirculated and/or treated by an Eddy separator in much the same manner as already described above in relation to the configuration depicted in FIG. 1 or FIG. 3. In the depicted embodiment, a crushed ½″ minus glass, after treatment in a high temperature dryer, was used to feed the crusher.

In the depicted embodiment, the coarse stream (5) was produced from the screener pan/fines as determined by use of a minimum #100 screen (or equivalent) as bottom screen and fed to a storage silo (i.e. feed bin 38b). Material from the top screen decks above #70 mesh was recirculated to the crusher system for further size reduction. The fine stream (9) was produced between #70 and #100 (or in similar range) screens, and was fed a separate storage silo (i.e. feed bin 38a; as depicted) or may alternatively be layered with coarse stream in a common silo as a heterogeneous mixture.

In embodiments in which a separator unit (i.e. a vibratory screener, or equivalent, for example) is used for generating the coarse stream, the coarse stream may, optionally, vary somewhat from the coarse stream already described hereinabove. By way example, in certain embodiments, the coarse stream generated from the separator have one or more properties according to the following:

| | | Lower | Upper | | |
|---|---|---|---|---|---|
| | | (micron) | (micron) | | |
| Coarse | D50 | 60 | 120 | Lower Size | 15 |
| Stream: | D10 | 25 | 60 | (micron): | |
| | Topcut (D98) | 100 | 150 | Upper Size | 160 |
| | | | | (micron): | |

In another embodiment, there is provided herein a system or process for preparing a glass powder pozzolan product, the process comprising steps of providing a crushed waste glass, milling at least a portion of a coarse stream comprising a pulverized glass within a predetermined first particle size range to provide a fine stream within a predetermined second particle size range, and milling at least a portion of the coarse stream and at least a portion of the fine stream to provide the glass powder product. In another embodiment, the system or process may comprise providing a crushed waste glass, and milling at least a portion of a coarse stream comprising a pulverized glass within a predetermined first particle size range and at least a portion of a fine stream within a predetermined second particle size range to provide the glass powder product.

As will be understood, the crushed waste glass may comprise any suitable crushed waste glass feedstock, and may comprise contaminants typically found in post-consumer waste glass. The crushed waste glass feedstock may comprise finely crushed glass particles, as well as coarser glass particles.

In certain embodiments of the processes or systems described herein, the predetermined first particle size range and the predetermined second particle size range may be different from each other. In certain embodiments, the predetermined first particle size range and the predetermined second particle size range may be partially overlapping. In certain embodiments, the predetermined first particle size range and the predetermined second particle size range do not overlap. In certain embodiments, the first particle size range may be finer than the second particle size range.

In certain embodiments, the primary stream may be crushed and then mixed with crushed waste glass being directed to the screener. In certain embodiments, the primary stream may be mixed with incoming waste glass input feed, and the primary stream and incoming waste glass input feed may be crushed to provide the crushed waste glass being sorted at the screener.

In certain embodiments of the processes or systems described herein, the step of separating the primary stream based on size to provide a coarse stream and a fine stream, the fine stream having a predetermined second particle size range, may comprise screening the primary stream on a separator.

In still another embodiment of the processes or systems described herein, the process may further comprise a step of sorting at least a portion of the glass powder product in an air classifier to provide a glass powder product stream within a predetermined particle size range, and a reject glass powder product stream comprising glass powder excluded from the glass powder product stream.

Accordingly, in certain embodiments, processes or systems described herein may include a recirculation loop, whereby the reject glass powder product stream is returned to the mill to produce additional glass powder product stream. In certain embodiments, the reject glass powder product stream may be milled, or may be mixed with additional combined stream, coarse stream, or fine stream, or both, and milled. In certain embodiments, ratio of the combined stream, the coarse stream, or the fine stream to the reject glass powder product stream provided to the mill may be adjusted to provide a desired glass powder product output.

In yet another embodiment, the air classifier may be configured to recover ultra-fine glass powder product based on material mass to air mass ratio within the air classifier, thereby providing an ultra-fine glass powder product having a leptokurtic particle size curve as the glass powder product stream.

In still another embodiment of the processes or systems described herein, the glass powder product may comprise a particle size D50 range from about 20 microns to about 1.2 microns.

In another embodiment of the processes or systems described herein, the process may further comprise a step of adjusting the ratio of the coarse stream to the fine stream in the combined stream to provide the glass powder product as an ultra-fine glass powder product having a target leptokurtic particle size distribution.

In still another embodiment, there is provided herein a process or system for preparing a glass powder product, comprising providing a coarse stream comprising a pulverized glass within a first particle size range, providing a fine stream comprising a pulverized glass within a second particle size range, and milling the coarse stream and the fine stream to provide the glass powder product.

In another embodiment, there is provided herein a process for preparing a glass powder pozzolan product from a waste glass input feed, the process comprising steps of crushing the waste glass input feed in a crusher to provide a crushed waste glass and milling the coarse stream within a predetermined first particle size range and the fine stream within a predetermined second particle size range to provide the glass powder product.

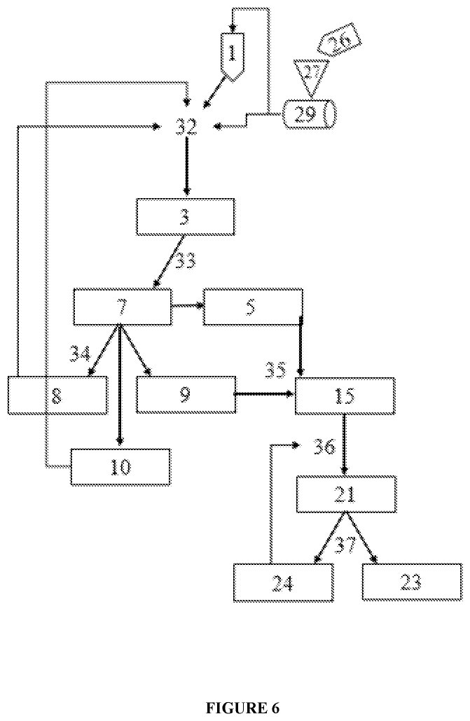

The systems depicted in FIGS. 1, 2 and 5 are shown performing an embodiment of a process as described herein. As well, an example of a process for preparing a glass powder product as described herein is depicted in FIG. 6. With reference to FIG. 6, the depicted process example comprises:
providing a crushed waste glass (32);
combining (35) at least a portion of the coarse stream (5) comprising a pulverized glass within a predetermined first particle size range and at least a portion of the fine stream (9) having a predetermined second particle size range to provide a combined stream (15); and
milling (36) at least a portion the combined stream (15) to provide the glass powder product (21).

In the depicted process embodiment, the crushed waste glass (32) is generated from a waste glass input feed (1) via crushing in a crusher (2), and/or from a post-consumer waste glass (26) which has been crushed in crusher (27) (and/or crushed in crusher (2)) and heated in high temperature dryer (29).

As shown, the depicted process is a dry process, which does not input water or liquid.

In the depicted process, at least a portion of the primary stream (8) is transferred to the crusher (2) to generate additional crushed glass waste (32). The primary stream (8) is added to the crusher (2) along with waste glass input feed (1) and/or post-consumer waste glass, thus generating additional crushed waste glass (32) for repeating the process. In the depicted example, the primary stream (8) is optionally passed through an Eddy separator en route to the crusher (2), to remove aluminum or other non-ferrous metals and/or residual plastic therefrom.

In the depicted process, the separating (34) additionally outputs an reject stream (10), which may be obtained separately and used for different applications, or may be transferred to crusher (2) to generate additional crushed waste glass (32) for repeating the process. The reject stream (10) may be passed through an Eddy separator en route to the crusher in certain embodiments to remove aluminum or other non-ferrous metals and/or residual plastic.

Accordingly, in the process depicted in FIG. 6, there is a re-circulation loop in which certain materials from the crushed waste glass (32) which are not recovered in the coarse stream (5) and the fine stream (9) are circulated back, optionally via an Eddy separator (12), to the crusher (2) and then through the process again.

In the depicted embodiment, the combining (35) may include adjusting the ratio of the coarse stream (5) to the fine stream (9) making up the combined stream (15), by adjusting feed rates of the coarse stream and the fine stream to the mixing unit (16), or otherwise controlling the ratio thereof in the combined stream (15).

As shown in FIG. 6, the depicted process comprises milling (36) of the combined stream (15) to provide the glass powder product (21), the glass powder product (21) comprising an ultra-fine glass powder product having a target leptokurtic particle size distribution.

As shown in FIG. 6, the depicted process example further comprises separating (37) the glass powder product (21) using an air classifier to sort the glass powder product (21) to provide a glass powder product stream (23) within a predetermined particle size range, and a reject glass powder product stream (24) comprising glass powder excluded from the glass powder product stream (23). The reject glass powder product stream (24) may then be returned back for further milling (36) either alone or mixed with the combined stream (15) to generate additional glass powder product (21) or glass powder product stream (23). The ratio of the reject glass powder product stream (24) to the combined stream (15) may be adjusted to provide a desired glass powder product (21) following milling.

Thus, in the depicted embodiment, the process comprises a second recirculation loop, whereby reject glass powder product stream (24) is recirculated for re-milling (36) to generate additional glass powder product (21) and/or glass powder product stream (23).

In the depicted process, the air classifier is configured to recover ultra-fine glass powder product based on material mass to air mass ratio within the air classifier (22), thereby providing an ultra-fine glass powder product having a leptokurtic particle size curve as the glass powder product stream (23).

Although not shown, the depicted system may further comprise an upstream milling unit, wherein the fine stream (9) is milled prior to combining with the coarse stream (5) at the mixing unit (16).

As well, although not shown, the depicted process may further comprise adding an anti-static grinding aid to the combined stream (15) prior to milling (36); and/or may comprise exposing the glass powder product (21) and/or glass powder product stream (23) to antistatic air jets configured to remove static therefrom.

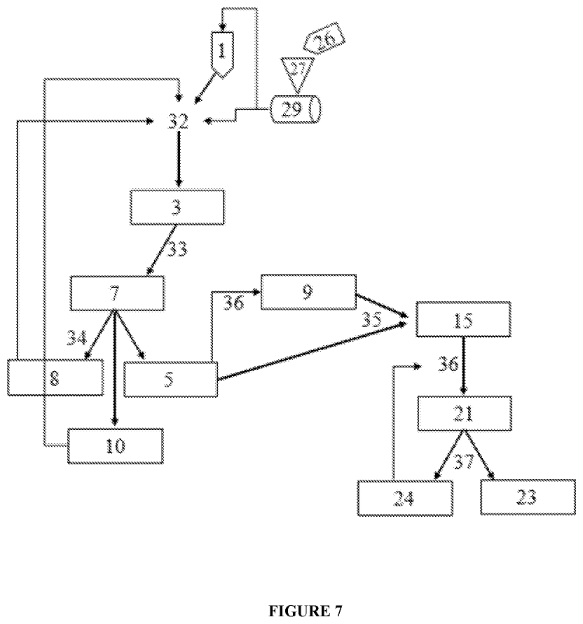

The systems depicted in FIGS. 3-4 are shown performing an embodiment of a process as described herein. As well, an example of a process for preparing a glass powder product as described herein is depicted in FIG. 7. With reference to FIG. 7, the depicted process example comprises:
providing a crushed waste glass (32);
milling (36) at least a portion of the coarse stream (5) comprising a pulverized glass within a predetermined first particle size range to provide the fine stream (9) having a predetermined second particle size range;
combining (35) at least a portion of the coarse stream (5) and at least a portion of the fine stream (9) to provide a combined stream (15); and
milling (36) at least a portion the combined stream (15) to provide the glass powder product (21).

In the depicted process embodiment, the crushed waste glass (32) is generated from a waste glass input feed (1) via crushing in a crusher (2), and/or from a post-consumer waste glass (26) which has been crushed in crusher (27) (and/or crushed in crusher (2)) and heated in high temperature dryer (29).

As shown, the depicted process is a dry process, which does not input water or liquid.

In the depicted process, at least a portion of the primary stream (8) is transferred to the crusher (2) to generate additional crushed glass waste (32). The primary stream (8) is added to the crusher (2) along with waste glass input feed (1) and/or post-consumer waste glass, thus generating additional crushed waste glass (32) for repeating the process. In the depicted example, the primary stream (8) is optionally passed through an Eddy separator en route to the crusher (2), to remove aluminum or other non-ferrous metals and/or residual plastic therefrom.

In the depicted process, the separating (34) additionally outputs an reject stream (10), which may be obtained separately and used for different applications, or may be transferred to crusher (2) to generate additional crushed waste glass (32) for repeating the process. The reject stream (10) may be passed through an Eddy separator en route to the crusher in certain embodiments to remove aluminum or other non-ferrous metals and/or residual plastic.

Accordingly, in the system depicted in FIG. 7, there is a re-circulation loop in which certain materials from the crushed waste glass (32) which are not recovered in the coarse stream (5) are circulated back, optionally via an Eddy separator (12), to the crusher (2) and then through the process again.

In the depicted embodiment, the combining (35) may include adjusting the ratio of the coarse stream (5) to the fine stream (9) making up the combined stream (15), by adjusting feed rates of the coarse stream and the fine stream to the mixing unit (16), or otherwise controlling the ratio thereof in the combined stream (15).

As shown in FIG. 7, the depicted process comprises milling (36) of the coarse stream (5) to provide the fine stream (9).

As shown in FIG. 7, the depicted process comprises milling (36) of the combined stream (15) to provide the glass powder product (21), the glass powder product (21) comprising an ultra-fine glass powder product having a target leptokurtic particle size distribution.

As shown in FIG. 7, the depicted process example further comprises separating (37) the glass powder product (21) using an air classifier to sort the glass powder product (21) to provide a glass powder product stream (23) within a predetermined particle size range, and a reject glass powder product stream (24) comprising glass powder excluded from the glass powder product stream (23). The reject glass powder product stream (24) may then be returned back for further milling (36) either alone or mixed with the combined stream (15) to generate additional glass powder product (21) or glass powder product stream (23). The ratio of the reject glass powder product stream (24) to the combined stream (15) may be adjusted to provide a desired glass powder product (21) following milling.

Thus, in the depicted embodiment, the process comprises a second recirculation loop, whereby reject glass powder product stream (24) is recirculated for re-milling (36) to generate additional glass powder product (21) and/or glass powder product stream (23).

In the depicted process, the air classifier is configured to recover ultra-fine glass powder product based on material mass to air mass ratio within the air classifier (22), thereby providing an ultra-fine glass powder product having a leptokurtic particle size curve as the glass powder product stream (23).

As well, although not shown, the depicted process may further comprise adding an anti-static grinding aid to the combined stream (15) prior to milling (36); and/or may comprise exposing the glass powder product (21) and/or glass powder product stream (23) to antistatic air jets configured to remove static therefrom.

As will also be understood, in certain embodiments, it is contemplated that the separator configuration depicted in FIG. 1 may alternatively be configured with a single separator unit (i.e. a vibratory screener, for example).

### Glass Powder Pozzolan Products

Also provided herein are glass powder pozzolan products having particular properties, which may be desirable for use as, for example, an additive in concrete mixtures and other like construction products. In certain embodiments, such glass powder pozzolan products may be produced by processes and/or systems as described herein.

In certain embodiments, there is provided herein a glass powder pozzolan product comprising one or more of: a brightness L* CIE of about 90% or greater; a particle size range based on mean of about 2.5 to about 6 microns; a specific surface area range of about 16000 to about 27000 cm²/mL; a particle size D50 of about 2 to about 7 microns; a particle size D10 of about 0.7 microns to about 2 microns; a particle size D98 of about 6 microns to about 20 microns; a leptokurtic particle size distribution; an LOI content<0.5%; a moisture level of <0.5%; a refractive index of about 1.5; a round or angular particle shape; or a micro-crystalline silica content of about 0; or any combination thereof. As will be understood, references herein to ranges may be understood as including embodiments having sub-ranges falling within the recited ranges, bounded on upper and lower ends by values (either integer values, or values rounded to the nearest 0.1, for example) from within the recited ranges.

In certain embodiments, the glass powder pozzolan products may comprise a generally leptokurtic particle size distribution. In certain embodiments, the glass powder product may comprise a particle size D50 range of from about 7 microns to about 2 microns. In certain embodiments, the glass powder product may comprise a brightness level at or exceeding about 90 L on a standardized CIE scale (65/10 observant). In another embodiments, the glass powder pozzolan product may comprise a brightness level at or exceeding about 95 L on a standardized CIE scale (65/10 observant).

In certain embodiments, glass powder products may be free of crystalline silica; may have low oil absorption; may have a low refractive index (i.e. about 1.5 in certain examples); may be resistant in most acidic formations; and/or may have a substantially angular particle shape (see FIG. 5).

As will be understood, in certain embodiments, the glass powder products described herein may be for use as a cement replacement in concrete mixtures. By way of example, glass powder pozzolan products described herein may be for use to improve performance of concrete mixtures in relation to strength gain and ASR reduction. In certain embodiments glass powder pozzolan products may be used in admixtures that are provided to concrete mixes.

### Example 1—Generation of Glass Powder Products

This example describes an example run, which was performed using a system similar to that depicted in FIGS. 1 and 2 to produce a glass powder pozzolan product.

The system was configured as follows:
Screen Deck (i.e. separator) settings:
   Deck 1 #4 Mesh TBC
   Deck 2 #8 Mesh TBC
   Deck 3 #12 Mesh MG
   Deck 4 #84 Mesh MG
   Deck 5 #270 Mesh TBC;

Products produced: #12 minus fibreglass product (produced from intermediate screen decks, for use in fibreglass products), and coarse stream for mill feed.

The coarse stream and the fine stream were combined in common storage silo, and used to supply a mill feed bin.

The glass powder pozzolan product was produced as by milling, using the following configuration:
Fresh feed addition: 0.5 to 1.5 tph;
Recirculation feed: 4-6 tph;
Mill Speed: 59 rpm (78% of critical);
Mill Classifier speed: 1600-1800 rpm; and
Mill Classifier Fan speed: 1500-1650 rpm.

Characterization of the thus produced glass powder product provided the following results:
D50 of 4.3;
Topcut (D98) of 15;
Specific Surface of 19,000-22000 cm2/mL;
Brightness: 93.7 L;
LOI: 0.2%
Moisture: 0.1%

### Example 2—Example of a Combined Stream Comprising a Coarse Stream and a Fine Stream

Particle size distribution of another example of a combined stream comprising an example of a coarse stream and an example of a fine stream as described herein is shown in FIG. 8. The combined stream has a bimodal particle size distribution, and comprises a mixture of coarse and fine streams at a mass ratio of about 80% coarse stream, and about 20% fine stream. As described herein, using coarse and fine streams such as these may provide a bimodal feedstock, milling of which may provide a glass powder product having desirable properties such as, for example, a leptokurtic particle size distribution.

One or more illustrative embodiments have been described by way of example. It will be understood to persons skilled in the art that a number of variations and modifications can be made without departing from the scope of the invention as defined in the claims.

What is claimed is:

1. A process for preparing a glass powder pozzolan product, the process comprising steps of:
providing a crushed waste glass with a loss on ignition (LOI) less than about 0.5% and moisture less than about 0.5%, wherein the step of providing the crushed waste glass comprises providing a waste glass input feed, and crushing the waste glass input feed to provide the crushed waste glass;
scalping the crushed waste glass from production of other glass products to produce a primary stream;
separating the primary stream on a separator, wherein the separator separates the primary stream based on size to provide a coarse stream, the coarse stream comprising a pulverized glass within a predetermined first particle size range of about 5 to about 800 microns;
milling at least a portion of the coarse stream to generate a fine stream, the fine stream comprising glass within a predetermined second particle size range of about 2 to about 200 microns;
adding the fine stream to the coarse stream;
milling at least a portion of the coarse stream and at least a portion of the fine stream to provide the glass powder pozzolan product, wherein the coarse stream and the fine stream are provided as a substantially heterogeneous mixture;
wherein the step of milling to provide the fine stream comprises milling in a first ball mill with a charge porosity configured for production of fines and wherein the step of milling to provide the glass powder pozzolan product comprises milling in a second ball mill with a charge porosity configured for production of ultra-fines.

2. The process of claim 1, further comprising a step of:
separating the primary stream on the separator, wherein the separator separates the primary stream based on size to provide the coarse stream, and the fine stream prior to the step of adding the fine stream to the coarse stream.

3. The process of claim 1, wherein the separator is a multi-deck screener comprising one or more of:
an upstream deck with a coarse mesh screen outputting the primary stream, a downstream deck with a fine mesh screen outputting the fine stream, and one or more intermediate decks each with an intermediate mesh screen for outputting one or more reject streams, wherein the fine mesh screen of the downstream deck has a mesh size of about 90 to about 150 mesh, or higher; and wherein materials which pass through the coarse mesh screen but which do not pass through the fine mesh screen are output as a reject stream.

4. The process according to claim 1, further comprising:
sorting at least a portion of the glass powder product in an air classifier to provide a glass powder pozzolan product stream within a predetermined particle size range being a D50 range from about 20 microns to about 1.2 microns, and a reject glass powder product stream comprising glass powder excluded from the glass powder pozzolan product stream, wherein the air classifier recovers ultra-fine glass powder pozzolan product based on a material mass to air mass ratio within the air classifier, thereby providing an ultra-fine glass powder pozzolan product having a leptokurtic particle size curve as the glass powder pozzolan product stream.

5. The process of claim 1, further comprising:
generating at least a portion of the crushed waste glass or the waste glass input feed from post-consumer waste glass;
crushing the post-consumer waste glass, wherein: the crushed waste glass comprises glass from post-consumer waste glass which has been color-sorted; the crushed waste glass comprises clear or white bottle glass, and is substantially free of colored glass; the crushed waste glass comprises mixed colored glass with a mean of green/flint glass ranging from about 50% to about 85%; or any combination thereof;
treating the post-consumer waste glass in a high-temperature dryer to destroy paper, light plastic, and organic contaminants, wherein the high-temperature dryer comprises a rotary kiln dryer and/or a tumbler dryer;
cooling the post-consumer waste glass on a fluidized bed cooler; and
removing ferrous metal contaminants from the post-consumer waste glass.

6. The process of claim 1, wherein the coarse stream comprises a pulverized glass having a D50 of about 100 to about 150 micron, a D98 of about 120 to about 700 micron and a D10 of about 20 to about 50 micron; and wherein the fine stream comprises a pulverized glass having a D50 of about 20 to about 50 micron, a D98 of about 80 to about 140 micron and a D10 of about 5 to about 15 micron.

7. The process of claim 1, wherein the glass powder pozzolan product comprises a brightness level at or exceeding 90 L on a standardized CIE color scale (65/10 observant).

8. The process of claim 1, wherein the glass powder pozzolan product comprises a brightness level at or exceeding 95 L on a standardized CIE color scale (65/10 observant).

9. A system for preparing a glass powder pozzolan product, the system comprising:
a crushed waste glass input;
a crusher configured to receive a waste glass input feed to crush the waste glass input feed to provide a crushed waste glass, and to provide the crushed waste glass to the crushed waste glass input;
a separator in communication with the crushed waste glass input and configured to receive a primary stream, wherein the separator separates the primary stream based on size to provide a coarse stream comprising pulverized glass within a predetermined first particle size range being about 5 to about 800 microns;
a mill configured to receive at least a portion of the coarse stream to mill the coarse stream to provide a fine stream, the fine stream having a predetermined second particle size range being about 2 to about 200 microns, wherein the mill comprises a ball mill with a charge porosity configured for production of fines; and
a mill configured to receive at least a portion of the coarse stream, and at least a portion of the fine stream or a mixture thereof, to mill the coarse stream and the fine stream to provide the glass powder pozzolan product, wherein the system is configured to provide a feed rate of the coarse stream and the fine stream to the mill, or a mixing unit upstream thereof, such that the coarse stream and the fine stream are provided as a substantially heterogeneous mixture and wherein the mill is configured to receive the coarse stream and the fine stream, either separately or as a combined stream, and to perform milling to provide the glass powder product, wherein the mill comprises a ball mill with a charge porosity configured for production of ultra-fines.

10. The system of claim 9, wherein
the separator is configured to separate the primary stream based on size to provide the coarse stream, and the fine stream, wherein the separator separates the primary stream into the coarse stream and the fine stream, and wherein the separator is a multi-deck screener comprising an upstream deck with a coarse mesh screen configured to output the coarse stream and a downstream deck with a fine mesh screen configured to output the fine stream.

11. The system of claim 9, further comprising:
a pre-screen configured to remove large contaminants from the primary stream prior to the primary stream entering an Eddy separator; and
the Eddy separator in communication with the separator and configured to receive the primary stream from the separator and to treat the primary stream to remove aluminum or other non-ferrous metals and/or residual plastic therefrom, the Eddy separator further in communication with the crusher for transferring the primary stream to the crusher following the treatment.

12. The system of claim 9, wherein the separator is a multi-deck screener comprising an upstream deck with a coarse mesh screen configured to output the coarse stream; a downstream deck with a fine mesh screen configured to output the fine stream; one or more intermediate decks each with an intermediate mesh screen, configured for outputting one or more reject streams; or any combination thereof, wherein the multi-deck screener is configured such that materials which pass through the coarse mesh screen but which do not pass through the fine mesh screen are output as a reject stream.

13. The system of claim 9, further comprising:
an air classifier in communication with the mill and configured to receive at least a portion of the glass powder product therefrom and to sort the glass powder product to provide a glass powder product stream within a predetermined particle size range, and a reject glass powder product stream comprising glass powder excluded from the glass powder product stream, wherein the air classifier is configured to recover ultra-fine glass powder product based on a material mass to air mass ratio within the air classifier, thereby providing an ultra-fine glass powder product having a target leptokurtic particle size curve as the glass powder pozzolan product stream.

14. The system of claim 9, wherein at least a portion of the crushed waste glass or the waste glass input feed is generated from a post-consumer waste glass, and wherein the system further comprises at least one of:
an initial crusher for crushing the post-consumer waste glass, the crusher configured to receive a waste glass input feed, to crush the waste glass input feed to provide a crushed waste glass, and to provide the crushed waste glass to the crushed waste glass input; and wherein a path leads the post-consumer waste glass to the crusher, the post-consumer waste glass providing at least a portion of the waste glass input feed for the crusher;
a high-temperature dryer configured to destroy paper, light plastic, and organic contaminants contained in the post-consumer waste glass, wherein the high temperature dryer is in communication with the crusher through a fluidized bed cooler configured along the path to cool the post-consumer waste glass; and
a magnet for removing ferrous metal contaminants from the post-consumer waste glass which is arranged along the path followed by the post-consumer waste glass, the path leading to the crushed waste glass input.

15. The system of claim 9, wherein the coarse stream comprises a pulverized glass having a D50 of about 100 to about 150 micron, a D98 of about 120 to about 700 micron and a D10 of about 20 to about 50 micron; and wherein the fine stream comprises a pulverized glass having a D50 of about 20 to about 50 micron, a D98 of about 80 to about 140 micron and a D10 of about 5 to about 15 micron.

16. A recycled glass-based powder pozzolan product made by the process of claim 1, comprising one or more of:
a brightness L* (CIE) of about 90% or greater;
an LOI of 0.5% or less;
a moisture of 0.5% or less; and
having a substantially leptokurtic particle size distribution.

17. The recycled glass-based powder pozzolan product of claim 16, further comprising:
a brightness L* (CIE) of about 96% or greater;

18. The recycled glass-based powder product pozzolan of claim 16, wherein the recycled glass-based powder product further comprises one or more of:
a particle size range based on mean of about 2.5 to about 6 microns;
a specific surface area range of about 16000 to about 27000 cm2/mL;
a particle size D50 of about 2 microns to about 7 microns;
a particle size D10 of about 0.9 microns to about 2 microns;
a particle size D98 of about 6 microns to about 20 microns;
a refractive index of about 1.5;
a round or angular particle shape;
a micro-crystalline silica content of about 0; or
any combination thereof.

19. The recycled glass-based powder product pozzolan of claim 16, wherein the product is a cement replacement.
